(19) United States
(12) Patent Application Publication
(10) Pub. No.: US 2026/0038887 A1
(43) Pub. Date: Feb. 5, 2026

(54) Separator For Power Storage Device

(71) Applicant: Asahi Kasei Battery Separator Corporation, Tokyo (JP)

(72) Inventors: Wataru Mizutani, Tokyo (JP); Haruka Yokoyama, Tokyo (JP)

(73) Assignee: Asahi Kasei Battery Separator Corporation, Tokyo (JP)

(21) Appl. No.: 19/285,373

(22) Filed: Jul. 30, 2025

(30) Foreign Application Priority Data
Jul. 31, 2024 (JP) 2024-125010
Jul. 31, 2024 (JP) 2024-125013
Jul. 1, 2025 (JP) 2025-111260

(51) Int. Cl. H01M 10/42; H01M 10/0525; H01M 50/42; H01M 50/443; H01M 50/446; H01M 50/449; H01M 50/489

(52) U.S. Cl. CPC H01M 10/4235; H01M 10/0525; H01M 50/42; H01M 50/443; H01M 50/446; H01M 50/449; H01M 50/489

(57) ABSTRACT

Provided is a multilayer porous membrane having a polyolefin microporous membrane, and a porous layer that contains inorganic particles and a water-soluble polymer binder, layered on the microporous membrane, wherein an air permeability of the multilayer porous membrane is 300 sec/100 cm³ or lower, a thickness of the porous layer on at least one side of the microporous membrane is 0.01 μm or greater and less than 5.00 μm, a mean particle size D₅₀ of the inorganic particles is 0.01 μm or larger and smaller than 0.50 μm, and a water-soluble polymer binder comprises a (meth)acrylamide-derived monomer unit at greater than 30.0% by weight and 99.0% by weight or lower and a cyano group-containing monomer unit at 1.0% by weight or greater and lower than 70.0% by weight.

### TECHNICAL FIELD

The present invention relates to a multilayer porous membrane, and more specifically it relates to a multilayer porous membrane that can be suitably used as a separator to be disposed between a positive electrode and negative electrode in a nonaqueous electrolyte solution battery.

### BACKGROUND ART

In a conventional nonaqueous electrolyte solution battery, it is common for a power generating element comprising a separator lying between a positive plate and negative plate to be impregnated with an electrolyte solution. Separators are generally required to have ion permeability and to also exhibit safety, including a shutdown function, and for this reason separators comprising microporous membranes with polyolefin resins have been used.

Multilayer porous membranes having a heat-resistant layer comprising inorganic particles and a binder formed on a polyolefin microporous membrane, for the purpose of improving heat resistance, are also known as separators for nonaqueous electrolyte solution batteries. Porous layers comprising polymers that contain inorganic fillers and structural units derived from (meth)acrylamide (also generally abbreviated as “PAAM”) have been investigated as heat-resistant layers (Patent Documents 1 to 5).

Patent Document 1 discloses obtaining a multilayer porous membrane by coating a filler having a predetermined mean particle size and a latex comprising 70 to 99% by weight of PAAM onto a microporous membrane as the substrate, from the viewpoint of preventing filler shedding from the multilayer porous membrane or porous layer, heat shrinkage resistance, and high output and high-temperature cycle characteristics of the battery. However, Patent Document 1 does not describe the air permeability of the multilayer porous membrane, the air permeability of the porous layer comprising the filler and PAAM, the basis weight-equivalent puncture strength of the microporous membrane, or the weight-average molecular weight of the PAAM.

Patent Document 2 discloses using a slurry comprising PAAM with a weight-average molecular weight of 300,000 to 6,000,000 to form a coating layer on a substrate, from the viewpoint of high peel strength between the substrate and the coating layer, as well as battery charge-discharge characteristics and storage stability of the slurry. However, Patent Document 2 does not specifically mention the air permeability and heat shrinkage factor of a multilayer porous membrane comprising the substrate and a coating layer, or the air permeability of the coating layer, the basis weight-equivalent puncture strength of the substrate or the mean particle size of the slurry.

In order to ensure high peel strength between the substrate and porous layer and high heat resistance of the porous layer, Patent Document 3 discloses providing a porous layer on the substrate using PAAM comprising a monomer unit derived from acrylamide at greater than 80% by weight and less than 95% by weight, acrylonitrile at greater than 0% by weight and 15% by weight or lower, and acrylic acid at greater than 0% by weight and 15% by weight or lower. However, Patent Document 3 does not specifically mention the air permeability of the multilayer porous membrane comprising the substrate and porous layer, the air permeability of the porous layer, the basis weight-equivalent puncture strength of the substrate, or the additives or physical properties of the slurry comprising the inorganic particles and PAAM.

Patent Document 4 discloses a multilayer porous membrane comprising 20 to 80% by weight of PAAM and hydrazide, from the viewpoint of filler bindability, adhesiveness, battery rate characteristic and output characteristic. However, Patent Document 4 does not examine the air permeability of the multilayer porous membrane comprising the microporous membrane and porous layer, the air permeability of the porous layer, the basis weight-equivalent puncture strength of the microporous membrane, the physical properties of the inorganic particles used in the porous layer or the shape and physical properties of the polymer.

Patent Document 5 discloses coating a porous polyolefin resin substrate with a slurry comprising PAAM and non-conductive particles with a specified mean particle size, wherein a divalent or higher metal ion is added at 1 ppm by weight to 47 ppm by weight to obtain satisfactory coatability and non-conductive particle bindability. However, Patent Document 5 does not concretely mention the air permeability of the porous layer comprising the non-conductive particles and PAAM, the air permeability and heat shrinkage factor of the multilayer porous membrane comprising the porous polyolefin resin substrate and porous layer, or the basis weight-equivalent puncture strength of the porous polyolefin resin substrate.

### RELATED ART

### Patent Document

[Patent Document 1] International Patent Publication No. WO2017/195563

[Patent Document 2] Japanese Unexamined Patent Publication No. 2014-067681

[Patent Document 3] Japanese Patent Public Inspection No. 2023-551961

[Patent Document 4] International Patent Publication No. WO2023/053990

[Patent Document 5] International Patent Publication No. WO2023/182119

### SUMMARY OF THE INVENTION

### Problems to Be Solved by the Invention

In recent years, from the viewpoint of improving battery capacity, it has become increasingly desirable to reduce the thickness of nonaqueous electrolyte solution battery separators that do not contribute to charge-discharge reaction, and to reduce the thicknesses of heat-resistant layers that are layered or coated on separator substrates. The heat-resistant layer thickness can be reduced by employing inorganic particles with relatively small particle sizes, but since this increases the surface area of the inorganic particles, it has been a goal to achieve even more efficient binding with binders than in the prior art. Specifically, the problem is that when the particle sizes of the inorganic particles are reduced and the amount of binder is increased to ensure binding between the inorganic particles and ensure heat resistance, the air permeability and resistance of the nonaqueous electrolyte solution battery separator increase and the output characteristic and cycle characteristic of the nonaqueous electrolyte solution battery are reduced. Consequently, it has not been possible to obtain conventional multilayer porous membranes as described in Patent Documents 1 to 5 as nonaqueous electrolyte solution battery separators having heat-resistant layers with thin layers, and exhibiting both high heat resistance and low electrical resistance.

In light of these circumstances, it is an object of the present invention to provide a multilayer porous membrane that allows a thin heat-resistant layer with high heat resistance and low electrical resistance to be obtained, as well as a nonaqueous electrolyte solution battery separator and a nonaqueous electrolyte solution battery comprising it.

### Means for Solving the Problems

The aforementioned problem is solved by the following technical means.
(1) A multilayer porous membrane having a microporous membrane comprising a polyolefin resin as a main component, and a porous layer that contains inorganic particles and a water-soluble polymer binder, layered on at least one side of the microporous membrane, wherein:
an air permeability of the multilayer porous membrane is 300 sec/100 cm³ or lower,
a thickness of the porous layer on at least one side of the microporous membrane is 0.01 μm or greater and less than 5.00 μm,
a mean particle size D₅₀ of the inorganic particles is 0.01 μm or greater and less than 0.50 μm, and
a water-soluble polymer binder comprises a (meth)acrylamide-derived monomer unit at greater than 30.0% by weight and 99.0% by weight or lower and a cyano group-containing monomer unit at 1.0% by weight or greater and lower than 70.0% by weight.
(2) The multilayer porous membrane according to [1] above, wherein a basis weight-equivalent puncture strength of the microporous membrane is 0.49 N/(g/m²) or greater.
(3) The multilayer porous membrane according to [1] or [2] above, wherein an air permeability of the porous layer is 100 sec/100 cm³ or lower.
(4) The multilayer porous membrane according to any one of [1] to [3] above, wherein the water-soluble polymer binder is non-particulate, and a weight-average molecular weight of the water-soluble polymer binder is 300,000 or higher.
(5) The multilayer porous membrane according to any one of [1] to [4] above, wherein the water-soluble polymer binder comprises a (meth)acrylic acid monomer unit at less than 20.0% by weight.
(6) The multilayer porous membrane according to any one of [1] to [5] above, wherein the multilayer porous membrane comprises a water-insoluble polymer binder.
(7) The multilayer porous membrane according to any one of (1) to (6) above, wherein a 150° C. heat shrinkage factor of the multilayer porous membrane is 10% or lower in both the MD and TD.
(8) The multilayer porous membrane according to any one of (1) to (7) above, wherein the multilayer porous membrane is a nonaqueous electrolyte solution battery separator.
(9) A nonaqueous electrolyte solution battery provided with a positive electrode, the multilayer porous membrane according to any one of [1] to [8] above, a negative electrode and a nonaqueous electrolyte solution.

### Effects of the Invention

According to the invention it is possible to provide a multilayer porous membrane having a heat-resistant layer that is thin and exhibits both high heat resistance and low electrical resistance, and to use the same in order to realize a nonaqueous electrolyte solution battery separator and a nonaqueous electrolyte solution battery.

### MODE FOR CARRYING OUT THE INVENTION

An embodiment for carrying out the invention (hereunder abbreviated as “the embodiment”) will now be described in detail as an example, with the understanding that the invention is not limited to the embodiment. The upper limits and lower limits for the numerical ranges throughout the present specification may be combined as desired. That a member contains a specific component as a main component means that the content of the specific component is 50% by weight or greater based on the mass of the member. Unless otherwise specified, the physical properties and numerical values described herein are those measured or calculated by the methods described in the Examples.

As used herein, “MD” refers to the machine direction during continuous molding of a polyolefin microporous membrane, and “TD” refers to the direction transversing the MD of the polyolefin microporous membrane at a 90° angle.

As used herein, the term “(meth)acrylic” refers to both acrylic and methacrylic, the term “(meth)acrylate” refers to both acrylate and methacrylate, and the term “(meth)acrylonitrile” refers to both acrylonitrile and methacrylonitrile.

### Multilayer Porous Membrane

The multilayer porous membrane of the embodiment is provided with a porous membrane comprising a polyolefin resin as the main component (hereunder also abbreviated as “PO microporous membrane”), and a porous layer that contains inorganic particles and a water-soluble polymer binder, layered on at least one side of the PO microporous membrane.

The multilayer porous membrane of the embodiment has an air permeability of 300 sec/100 cm³ or lower, the thickness of the porous layer on at least one side of the microporous membrane is 0.01 μm or greater and less than 5.00 μm, the mean particle size D₅₀ of the inorganic particles in the porous layer is 0.01 μm or larger and smaller than 0.50 μm, and the water-soluble polymer binder contains a (meth)acrylamide-derived monomer unit at greater than 30.0% by weight and 99.0% by weight or lower, and a cyano group-containing monomer unit at 1.0% by weight or greater and lower than 70.0% by weight.

As mentioned above, using inorganic particles with a relatively small size, i.e. a mean particle size D₅₀ of 0.01 μm or larger and smaller than 0.50 μm, while using a water-soluble polymer binder, such as a water-soluble polyacrylamide, having a (meth)acrylamide-derived monomer unit and a cyano group-containing monomer unit such as an acrylonitrile backbone in a specified proportion as the binder, it is possible to achieve high heat resistance for the porous layer disposed in the microporous membrane without increasing the total amount of the binder, and to thereby realize a multilayer porous membrane having a thin heat-resistant layer exhibiting both high heat resistance and low electrical resistance.

A porous layer comprising inorganic particles and a water-soluble polymer binder generally has a structure in which the inorganic particles are bound together by the water-soluble polymer binder covering their surfaces. Without being constrained to any particular theory, it is thought that since the multilayer porous membrane of the embodiment employs a water-soluble polymer binder such as polyacrylamide with high heat resistance as the water-soluble polymer binder, while a specified amount of a cyano group-containing monomer unit such as an acrylonitrile backbone is added to the polyacrylamide, it is possible to improve the bindability of the water-soluble polymer binder onto the inorganic particle surfaces and thus increase the heat resistance of the porous layer. According to this embodiment, adding a specified amount of a cyano group-containing monomer unit such as an acrylonitrile backbone to the polyacrylamide improves the dispersibility of the water-soluble polymer binder and allows high heat resistance to be achieved while limiting the total amount of the binder in the porous layer.

The multilayer porous membrane of the embodiment can be used as a nonaqueous electrolyte solution battery separator (hereunder also referred to simply as “separator”), and since it has a thin, highly heat-resistant and low-resistance porous layer, it can ensure electrical insulating properties (hereunder also referred to as “high-temperature insulating resistance”) even in harsh environments such as high temperatures, and can improve the energy density, capacity and output/cycle characteristics of the nonaqueous electrolyte solution battery.

The structure of the multilayer porous membrane may have a porous layer on one or both sides of the PO microporous membrane, and for example, it may be a two-layer structure comprising a first porous layer that includes inorganic particles and a PO microporous membrane, or a three-layer structure comprising, in order, a first porous layer, a PO microporous membrane, and a second porous layer that includes inorganic particles.

The multilayer structure is not limited to a two-layer structure (first porous layer-PO microporous membrane) or a three-layer structure (first porous layer-PO microporous membrane-second porous layer), and if desired, one or more additional layers may be formed between the first porous layer and the PO microporous membrane, between the second porous layer and the PO microporous membrane, or on at least one side or the outsides of the multilayer porous membrane, for example. Examples of additional layers include an additional PO microporous membrane, an additional porous layer including inorganic particles and a binder polymer, a resin layer comprising 50% by weight or greater of a resin other than polyolefin (PO), and a thermoplastic polymer-containing layer which includes a binder component having an adhesion function, such as a thermoplastic polymer.

In the multilayer porous membrane of the embodiment, preferably the thickness of the PO microporous membrane is 8 μm or smaller, the basis weight-equivalent puncture strength of the PO microporous membrane is 85 gf/(g/m²) or greater, the mean particle size D₅₀ of the inorganic particles in the porous layer is 0.05 μm or larger and smaller than 0.30 μm, the particle size D₉₀ of the inorganic particles in the porous layer is 0.10 μm to 0.45 μm, the total thickness of the porous layer is 0.1 μm to 3.0 μm, and the ratio of the light transmittance of the multilayer porous membrane at 550 nm and the light transmittance of the PO microporous membrane at 550 nm is 0.4 or higher and lower than 1.0.

Due to the unique combination in the aforementioned structure, the multilayer porous membrane of the embodiment can exhibit high optical transparency, high heat resistance, low resistance and a low membrane thickness. The relationship between the structure and high optical transparency, high heat resistance, low resistance or low membrane thickness is thought to be as follows, though it is not our intention to be constrained by any particular theory.

In regard to optical transparency, the void sections and the inorganic particles in the porous layer have different refractive indexes for light, which causes scattering to occur due to light refraction in the multilayer porous membrane, thus lowering the transparency. Conversely, it is thought that smaller dimensions for the inorganic particles reduce the difference in the refractive indexes of the void sections and inorganic particles, thus reducing light scattering and increasing the transparency. A smaller proportion of particles with relatively large particle sizes will help prevent scattering of light by the large-diameter particles, thus further increasing the transparency. Since the multilayer porous membrane of the embodiment has suitable optical transparency, extraneous material or unmelted material inside or on the surface of the substrate tends to be more easily verifiable after the porous layer has been disposed on the PO microporous membrane.

The heat resistance is believed to be an effect of the filler (the inorganic particles in the porous layer), and an effect of the resin binder that is present in the porous layer.

The effect of the filler on heat resistance is explained as being that a greater number of contact points between the filler, due to smaller particle sizes of the inorganic particles, diffuses shrinkage stress of the PO microporous membrane and increases the heat shrinkage resistance of the multilayer porous membrane. Conventionally when a multilayer porous membrane has been used as a nonaqueous electrolyte solution battery separator, increase in the battery temperature above the resin melting temperature due to thermal runaway causes the substrate layer to easily flow into the voids of the electrode layer, and when the nonaqueous electrolyte solution battery separator is too thin this has made it difficult to maintain insulation. With this embodiment, however, the smaller sizes of the inorganic particles in the porous layer situated on the substrate layer surface reduce flow of the resin, due to narrower pore diameters in the porous layer, thus blocking the molten resin from the substrate layer, for example, and improving the heat resistance of the battery.

As regards the effect of the resin binder on heat resistance, it is preferred to use a water-soluble polymer binder that has stable bindability even at high temperature when covering the inorganic particle surfaces in the porous layer, because the shape of the porous layer will be maintained even in high-temperature environments, and the heat resistance will be improved.

The constituent elements of the multilayer porous membrane of the embodiment will now be described.

### Porous Layer

The porous layer is a layer formed on at least one side of the microporous membrane comprising a polyolefin resin as the main component, and it comprises inorganic particles and a water-soluble polymer binder. If desired, the porous layer may also contain a binder other than the water-soluble polymer binder, and a dispersing agent.

If the thickness (T) of the porous layer is in the range of 0.01 μm≤T<5.00 μm on at least one side of the PO microporous membrane, then it will be possible to provide a thin layer with both high heat resistance and low electrical resistance, while ensuring high-temperature insulating resistance, thus allowing the energy density, capacity and output/cycle characteristic of the nonaqueous electrolyte solution battery to be improved. From the viewpoint of improving the high-temperature insulating resistance and battery characteristics, the thickness (T) of the porous layer on at least one side of the PO microporous membrane is preferably 4.00 μm or smaller, more preferably 3.00 μm or smaller, even more preferably 2.00 μm or smaller, yet more preferably 1.50 μm or smaller and most preferably 1.00 μm or smaller, while the lower limit is preferably 0.10 μm or larger and more preferably 0.50 μm or larger. When the multilayer porous membrane is to be used as a nonaqueous electrolyte solution battery separator, the porous layer is preferably thin from the viewpoint of improving the volumetric energy density of the power storage device, so long as the multilayer porous membrane can maintain an excellent balance of properties as a nonaqueous electrolyte solution battery separator.

The thickness of the porous layer T may have the porous layer formed only on at least one side of the PO microporous membrane, or optionally formed on both sides of the PO microporous membrane. When the porous layer is formed on both sides of the PO microporous membrane, the total thickness of the porous layer is preferably within the range specified above.

### Inorganic Particles

A smaller mean particle size D₅₀ of the inorganic particles in the porous layer, within a range satisfying 0.01 μm≤D₅₀<0.50 μm, will be more suitable for a water-soluble polymer binder containing a (meth)acrylamide-derived monomer unit and a cyano group-containing monomer unit, and it will be possible to obtain high heat resistance for the porous layer, thereby allowing a multilayer porous membrane to be obtained which has a thin heat-resistant layer exhibiting high heat resistance and low electrical resistance.

From the viewpoint of compatibility with the water-soluble polymer binder, and from the viewpoint of obtaining a thin porous layer exhibiting high heat resistance and low electrical resistance, the mean particle size D₅₀ of the inorganic particles is preferably 0.05 μm or larger, more preferably 0.06 μm or larger, even more preferably 0.07 μm or larger and most preferably 0.10 μm or larger, while from the same viewpoint, as well as from the viewpoint of maintaining high optical transparency to improve detection accuracy for contaminants in the multilayer porous membrane, D₅₀ is preferably 0.45 μm or smaller, more preferably 0.40 μm or smaller, even more preferably 0.30 μm or smaller and most preferably 0.20 μm or smaller.

From the viewpoint of compatibility with the water-soluble polymer binder and of obtaining a thin porous layer exhibiting high heat resistance and low electrical resistance, the mean particle size D₉₀ of the inorganic particles is preferably 0.10 μm or larger, more preferably 0.11 μm or larger, even more preferably 0.12 μm or larger and most preferably 0.20 μm or larger, while from the same viewpoint, as well as from the viewpoint of maintaining high optical transparency to improve detection accuracy for contaminants in the multilayer porous membrane, D₉₀ is preferably smaller than 0.70 μm, more preferably smaller than 0.50 μm, even more preferably smaller than 0.45 μm, yet more preferably smaller than 0.35 μm and most preferably 0.25 μm or smaller.

From the viewpoint of compatibility with the water-soluble polymer binder, and from the viewpoint of obtaining a thin porous layer exhibiting high heat resistance and low electrical resistance, the inorganic particle size D₁₀ of the porous layer is preferably 0.01 μm or larger, more preferably 0.03 μm or larger and even more preferably 0.04 μm or larger, while from the same viewpoint, as well as from the viewpoint of maintaining high optical transparency to improve detection accuracy for contaminants in the multilayer porous membrane, D₁₀ is preferably 0.20 μm or smaller, more preferably 0.15 μm or smaller and even more preferably 0.10 μm or smaller.

From the viewpoint of maintaining high optical transparency, the particle size, mean particle size and particle size distribution of the inorganic particles in the porous layer preferably satisfy the following relationships:

$${D}_{50} < 0.2 μm ; and \\ {D}_{90} < 0.35 μm .$$

From the viewpoint of obtaining a thin porous layer exhibiting both high heat resistance and low electrical resistance and of maintaining high permeability, the mean particle size D₅₀ and the mean particle size values D₉₀ and D₁₀ for the inorganic particles preferably satisfy the relationships represented by the following inequalities (1) and (2):

$${D}_{90} / {D}_{50} \leq 2. \qquad Inequality ( 1 )$$

$${D}_{50} / {D}_{10} \leq 2. . \qquad Inequaility ( 2 )$$

The upper limit for D₉₀/D₅₀ of the inorganic particles is preferably 2.0 or lower, more preferably 1.9 or lower and even more preferably 1.8 or lower, from the viewpoint of maintaining high optical transparency and maintaining heat resistance. The lower limit for D₉₀/D₅₀ is preferably 1.2 or higher, more preferably 1.3 or higher and even more preferably 1.4 or higher, from the viewpoint of maintaining ion permeability.

The upper limit for D₅₀/D₁₀ of the inorganic particles is preferably 2.0 or lower, more preferably 1.9 or lower, even more preferably 1.8 or lower and most preferably 1.7 or lower, from the viewpoint of maintaining high optical transparency. The lower limit for D₅₀/D₁₀ is preferably 1.2 or higher, more preferably 1.3 or higher and even more preferably 1.4 or higher, from the viewpoint of maintaining ion permeability.

The particle size, mean particle size or particle size distribution of the inorganic particles described above can be obtained by selection of the type of inorganic particle materials or by dispersion/stirring/particle size control of the inorganic particles in the inorganic particle-containing slurry, during the process of situating the porous layer on the microporous membrane or substrate, or during the separator production process, for example.

More specifically, the method of adjusting the particle size distribution of the inorganic particles may be, for example, a method of pulverizing the inorganic particles using a ball mill, bead mill or jet mill to obtain the desired particle size distribution, or a method of preparing multiple inorganic particles with different particle size distributions and then blending them.

The material of the inorganic particles used for the porous layer is not particularly restricted, but preferably it is a material with high heat resistance and electrical insulating properties, and one that is electrochemically stable in the range in which the nonaqueous electrolyte solution battery is to be used.

Examples of materials for the inorganic particles include oxide-based ceramics such as alumina, silica, titania, zirconia, magnesia, ceria, yttria, zinc oxide and iron oxide; nitride-based ceramics such as silicon nitride, titanium nitride and boron nitride; ceramics such as silicon carbide, calcium carbonate, magnesium sulfate, aluminum sulfate, barium sulfate, aluminum hydroxide, aluminum oxide hydroxide or boehmite, potassium titanate, talc, kaolinite, dickite, nacrite, halloysite, pyrophyllite, montmorillonite, sericite, mica, amesite, bentonite, asbestos, zeolite, calcium silicate, magnesium silicate, diatomaceous earth and quartz sand; and glass fibers. Preferred among these are one or more selected from the group consisting of alumina, boehmite and barium sulfate, from the viewpoint of stability in the nonaqueous electrolyte solution battery, with boehmite or barium sulfate being more preferred. The inorganic particles may be used alone, or more than one type may be used together.

Examples of inorganic particle forms include laminar, scaly, polyhedral, needle-like, columnar, granular, spherical, fusiform and block-shaped forms, and various combinations of inorganic particles with these forms may also be used. Inorganic particles having the different shapes mentioned above may also be used in combination.

The aspect ratio of the inorganic particles is preferably 1.0 to 3.0 from the viewpoint of the total porosity of the porous layer and of providing suitable binding points between the inorganic particles via the water-soluble polymer binder. The lower limit for the aspect ratio of the inorganic particles is preferably 1.0 or higher and more preferably 1.1 or higher, from the viewpoint of maintaining ion permeability. The upper limit for the aspect ratio of the inorganic particles is preferably 3.0 or lower, more preferably 2.0 or lower and even more preferably 1.5 or lower, from the viewpoint of reducing the moisture content of the porous layer and maintaining heat resistance. The aspect ratio of the inorganic particles can be determined by image analysis of an image taken by a scanning electron microscope (SEM).

The BET specific surface area of the inorganic particles is preferably 7.00 m²/g to 200 m²/g, more preferably 8.00 m²/g to 100 m²/g, even more preferably greater than 8.00 m²/g and 50.0 m²/g or less, and most preferably 10.0 m²/g to 30.0 m²/g. If the BET specific surface area of the inorganic particles is 7.00 m²/g or greater, the pores of the porous layer will be smaller and the current density of the nonaqueous electrolyte solution battery will be more uniform, thus tending to improve the cycle performance, while the number of contact points between the inorganic particles in the porous layer will also be increased, thus tending to improve the heat resistance. A mean particle size suited for the embodiment can be achieved more easily if the BET specific surface area of the inorganic particles is within the range specified above. The BET specific surface area of the inorganic particles is also preferably within this range from the viewpoint of reducing the moisture content of the porous layer.

The mass ratio (Wᵢ) of the inorganic particles in the porous layer is preferably 80% or higher, more preferably 85% or higher, even more preferably 90% or higher and most preferably 95% or higher. If the Wi ratio of the inorganic particles in the porous layer is 80% or higher, the proportion of other components such as the resin binder will be relatively reduced, and increase in the air permeability and/or battery resistance of the porous layer with respect to the PO microporous membrane will be inhibited, improving the battery characteristics. The upper limit for Wᵢ is not particularly restricted and may be lower than 100%, or 99% or lower, for example.

The volume ratio (Vᵢ) of the inorganic particles, for the volume which excludes the pore volume in the porous layer, is preferably 65% or greater, more preferably 70% or greater, even more preferably 75% or greater, yet more preferably 80% or greater and most preferably 85% or greater, with 100% by volume as the volume excluding the voids in the porous layer. If the value of Vᵢ for the inorganic particles in the porous layer is 65% or greater, the proportion of the inorganic particles will be higher with respect to the other components such as the resin binder, thus helping to reduce increase in air permeability of the PO microporous membrane caused by the porous layer, and to lower the electrical resistance of the multilayer porous membrane. The upper limit for Vi is not restricted but may be 95% or lower, 93% or lower, 92% or lower or 91% or lower, for example.

### Resin Binder

The porous layer comprises a water-soluble polymer binder as the resin binder, and optionally also a binder other than the water-soluble polymer binder.

The porous layer of the embodiment preferably contains a water-insoluble polymer binder in addition to the water-soluble polymer binder. The porous layer preferably has a structure in which the water-soluble polymer binder covers at least portions of the surfaces of the inorganic particles while the water-insoluble polymer binder diffuses in the porous layer to bind together the inorganic particles or the inorganic particles covered by the water-soluble polymer binder. Such a structure can reduce the moisture content in the porous layer and increase the heat resistance of the porous layer, while also increasing the peel strength between the porous layer and the PO microporous membrane.
Water-soluble polymer binder

The water-soluble polymer binder of the embodiment is used as a resin binder, and it is water-soluble. The water-soluble polymer binder of the embodiment is preferably a polymer with an insoluble portion of less than 1.0% by weight when 1.0 g of the polymer has been dissolved in 100 g of water at 25° C. The water-soluble polymer binder of the embodiment is preferably non-particulate.

If the water-soluble polymer binder comprises a (meth)acrylamide-derived monomer unit at greater than 30.0% by weight and 99.0% by weight or lower and a cyano group-containing monomer unit at 1.0% by weight or greater and lower than 70.0% by weight, then it will be more suitable for the relatively small-sized inorganic particles described above, allowing the amount of binder to be reduced while controlling the binding points between the inorganic particles, and providing the porous layer with high heat resistance.

If desired, the water-soluble polymer binder may include a repeating unit other than the (meth)acrylamide-derived monomer unit and cyano group-containing monomer unit.

From the viewpoint of compatibility with the inorganic particles and controlling the binding points of the inorganic particles, the lower limit for the content ratio of the (meth)acrylamide-derived monomer unit in the water-soluble polymer binder is preferably 40.0% by weight or greater, more preferably 50.0% by weight or greater, even more preferably 60.0% by weight or greater, yet more preferably 70.0% by weight or greater and most preferably 80.0% by weight or greater, and the upper limit is preferably 97.0% by weight or lower, more preferably 95.0% by weight or lower, even more preferably 85.0% by weight or lower and most preferably 90.0% by weight or lower.

The (meth)acrylamide-derived monomer unit may be introduced by (co)polymerization using (meth)acrylamide, a dialkyl (meth)acrylamide or a derivative thereof, for example, as the monomer.

From the viewpoint of compatibility with the inorganic particles and controlling the binding points of the inorganic particles, the lower limit for the content ratio of the cyano group-containing monomer unit in the water-soluble polymer binder is preferably 3.0% by weight or greater, more preferably 5.0% by weight or greater, even more preferably 10.0% by weight or greater, yet more preferably 15.0% by weight or greater and most preferably 20.0% by weight or greater, while the upper limit is preferably 60.0% by weight or lower, more preferably 50.0% by weight or lower, even more preferably 40.0% by weight or lower and most preferably 30.0% by weight or lower.

The cyano group-containing monomer unit may be introduced by (co)polymerization using a monomer with a cyano group and a polymerizable group, such as a monomer with a (meth)acrylonitrile backbone or cyanoacrylate backbone.

From the viewpoint of high heat resistance, the water-soluble polymer binder preferably contains a (meth)acrylic acid monomer unit, and from the viewpoint of optimizing heat resistance, it more preferably contains a (meth)acrylic acid monomer unit at less than 20.0% by weight, the content ratio of the (meth)acrylic acid monomer unit being even more preferably 10.0% by weight or lower, yet more preferably in the range of 0.0% by weight to 5.0% by weight and most preferably greater than 0.0% by weight and 2.0% by weight or lower.

For example, the (meth)acrylic acid monomer unit may be introduced by (co)polymerization using a monomer such as acrylic acid or methacrylic acid.

If desired, the water-soluble polymer binder may include a monomer unit derived from a (meth)acrylic acid ester. The content ratio of the (meth)acrylic acid ester-derived monomer unit in the water-soluble polymer binder is preferably in the range of 0.0% by weight to 20.0% by weight and more preferably greater than 0.0% by weight and less than 20.0% by weight.

A monomer unit derived from a (meth)acrylic acid ester may be introduced by (co)polymerization using a monomer such as an alkyl (meth)acrylate ester, examples of which include methyl acrylate, methyl methacrylate, ethyl acrylate, ethyl methacrylate, butyl acrylate, butyl methacrylate, 2-ethylhexyl acrylate and 2-ethylhexyl methacrylate.

For the purpose of the function and effect of the invention, the (meth)acrylic acid ester monomer preferably contains no hydroxyl groups.

Specific examples of water-soluble polymer binders include (meth)acrylamide-(meth)acrylonitrile copolymer, (meth)acrylamide-(meth)acrylonitrile-(meth)acrylic acid copolymer, (meth)acrylamide-(meth)acrylonitrile-(meth)acrylic acid ester copolymers and (meth)acrylamide-(meth)acrylonitrile-(meth)acrylic acid-(meth)acrylic acid ester copolymers.

From the viewpoint of improving the high heat resistance and peel strength of the porous layer, the weight-average molecular weight (Mw) of the water-soluble polymer binder preferably has a lower limit of 300,000 or higher, more preferably higher than 300,000, even more preferably 350,000 or higher, yet more preferably 400,000 or higher, even yet more preferably 500,000 or higher, especially preferably 600,000 or higher, particularly preferably 700,000 or higher, most especially preferably 800,000 or higher, much more preferably 900,000 or higher, and most preferably 1,000,000 or higher, and an upper limit of preferably 4,000,000 or lower, more preferably 3,000,000 or lower and even yet more preferably 2,000,000 or lower.

The ratio of the weight-average molecular weight (Mw) with respect to the number-average molecular weight (Mn) of the water-soluble polymer binder (hereunder referred to as “dispersity” or simply “Mw/Mn”) is preferably 30 or lower, more preferably 20 or lower, even more preferably 10 or lower, yet more preferably 5 or lower and most preferably 3 or lower, from the viewpoint of increasing the high heat resistance and high peel strength of the porous layer. The lower limit for Mw/Mn is not restricted and may be 1 or greater, for example.

From the viewpoint of ensuring high heat resistance for the porous layer while limiting the amount of binder, the mass ratio Wa of the water-soluble polymer binder in the porous layer is preferably 4.0% by weight or lower, more preferably 3.0% by weight or lower, even more preferably 2.0% by weight or lower and most preferably 1.0% by weight or lower, as the upper limit, and preferably 0.1% by weight or higher and more preferably 0.5% by weight or higher as the lower limit, based on the mass of the porous layer.
Water-insoluble polymer binder

For high peel strength and a low water content, as well as heat resistance, the porous layer preferably contains a water-insoluble polymer binder. The water-insoluble polymer binder is preferably a particulate polymer that becomes particulate when dispersed in water. The glass transition temperature (Tg) of the water-insoluble polymer binder is preferably 30° C. or lower and more preferably 10° C. or lower from the viewpoint of binding of the inorganic particles to increase the heat resistance.

There are no particular restrictions on the water-insoluble polymer binder, and it may be a particulate acrylic-based polymer, for example. An acrylic-based polymer is a polymer containing a (meth)acrylic compound as a monomer unit, and this is the preferred type of binder from the viewpoint of electrical resistance, with an acrylic-based polymer latex being even more preferred.

The acrylic-based polymer may be (meth)acrylic acid so long as it is water-insoluble and particulate. Examples of (meth)acrylic acid esters to be used as the acrylic-based polymer include alkyl (meth)acrylate esters such as methyl acrylate, methyl methacrylate, ethyl acrylate, ethyl methacrylate, butyl acrylate, butyl methacrylate, 2-ethylhexyl acrylate and 2-ethylhexyl methacrylate; or epoxy group-containing (meth)acrylic acid esters such as glycidyl acrylate or glycidyl methacrylate; any of which may be used alone or in combinations of two or more.

The acrylic-based polymer may be obtained by copolymerizing other monomers that are copolymerizable with the (meth)acrylic compound. Examples of other copolymerizable monomers to be used include unsaturated alkyl carboxylate esters, aromatic vinyl-based monomers, vinyl cyanide-based monomers, hydroxyalkyl group-containing unsaturated monomers, unsaturated amide carboxylate monomers, crotonic acid, maleic acid, maleic acid anhydride, fumaric acid and itaconic acid, any of which may be used alone or in combinations of two or more. Unsaturated alkyl carboxylate ester monomers are particularly preferred. Unsaturated alkyl carboxylate ester monomers include dimethyl fumarate, diethyl fumarate, dimethyl maleate, diethyl maleate, dimethyl itaconate, monomethyl fumarate and monoethyl fumarate, any of which may be used alone or in combinations of two or more.

Specific examples of acrylic-based polymers include methacrylic acid ester-acrylic acid ester copolymers, styrene-acrylic acid ester copolymers and acrylonitrile-acrylic acid ester copolymers.

The mean particle size (D₅₀) of the water-insoluble polymer binder is preferably adjusted depending on the desired reduction in sizes of the inorganic particles, but from the viewpoint of efficiently achieving binding at the interfaces between the inorganic particles or at the interfaces between the inorganic particles and the PO microporous membrane, the upper limit is preferably 0.20 μm or smaller, more preferably 0.15 μm or smaller, even more preferably 0.10 μm or smaller and most preferably 0.05 μm or smaller, while the lower limit is not particularly restricted and may be 0.01 μm or larger, for example.

From the viewpoint of heat shrinkage inhibiting ability and permeability, the mass ratio Wb of the water-insoluble polymer binder in the porous layer is preferably 0% by weight or higher and preferably higher than 0% by weight, as the lower limit, and preferably 5.0% by weight or lower, more preferably 4.0% by weight or lower, even more preferably 3.0% by weight or lower and most preferably 2.0% by weight or lower, as the upper limit.

From the viewpoint of limiting the amount of binder in the porous layer while controlling the binding points for the inorganic particles to obtain both high heat resistance and low electrical resistance for the porous layer, the mass ratio Wb of the water-insoluble polymer binder is preferably higher than the mass ratio Wa of the water-soluble polymer binder (that is, Wb/Wa>1.0), the lower limit for the ratio Wb/Wa being more preferably 4.0 or higher and even more preferably 4.5 or higher, and the upper limit for the Wb/Wa ratio being more preferably 8.0 or lower and even more preferably 7.0 or lower.
Other polymers

If desired, the porous layer may also comprise a polymer other than the polymer binder described above, examples of which include the following resins:
polyolefins: including polyethylene, polypropylene, ethylene-propylene rubber, and modified forms of the same;
conjugated diene-based polymers: including styrene-butadiene copolymers and their hydrogenated forms, acrylonitrile-butadiene copolymers and their hydrogenated forms, and acrylonitrile-butadiene-styrene copolymers and their hydrogenated forms;
polyvinyl alcohol-based resins: including polyvinyl alcohol and vinyl polyacetate;
fluorinated resins: including polyvinylidene fluoride, polytetrafluoroethylene, vinylidene-hexafluoropropylene fluoride-tetrafluoroethylene copolymer and ethylene-tetrafluoroethylene copolymer;
cellulose derivatives: including ethyl cellulose, methyl cellulose, hydroxyethyl cellulose and carboxymethyl cellulose; and
polymers with a melting point and/or glass transition temperature of 180° C. or higher, or without a melting point but having a decomposition temperature of 200° C. or higher: including polyphenylene ether, polysulfone, polyethersulfone, polyphenylene sulfide, polyetherimide, polyamideimide, polyamide, polyester and poly (meth)acrylamide.

When the multilayer porous membrane is to be used as a nonaqueous electrolyte solution battery separator, the porous layer may also comprise, as an additional polymer, a thermoplastic polymer for increased adhesion between the separator and electrodes. Such a thermoplastic polymer may have a glass transition temperature or melting point of 20° C. to 200° C., and the mean particle size may be 0.5 to 5 times the thickness of the porous layer.

From the viewpoint of high optical transparency, high heat resistance and low electrical resistance, the volume ratio of the water-soluble polymer including the water-soluble polymer binder in the porous layer is preferably 1% by volume to 10% by volume, where 100% by volume is the volume of the porous layer excluding the voids. The lower limit for the volume ratio of the water-soluble polymer in the porous layer is preferably 1.0% by volume or higher, more preferably 2.0% by volume or higher and even more preferably 2.5% by volume or higher, from the viewpoint of maintaining heat resistance. The upper limit for the volume ratio of the water-soluble polymer in the porous layer is preferably 10.0% by volume or lower, more preferably 9.5% by volume or lower and even more preferably 9.0% by volume or lower, from the viewpoint of maintaining ion permeability.

### Dispersing Agent

If desired, the porous layer may also include a dispersing agent in addition to the inorganic particles and resin binder. Examples of dispersing agents include polycarboxylic acid salts such as a polyacrylic acid salts, as well as sulfonic acid salts and polyoxy ethers. Sodium polyacrylate is an example of a polyacrylic acid salt that may be used. The dispersing agent content is preferably 0.0% by weight or greater, more preferably greater than 0.0% by weight, even more preferably 0.2% by weight or greater and most preferably 0.4% by weight or greater, based on the solid content of the porous layer. The dispersing agent content is also preferably 5.0% by weight or lower, more preferably 3.0% by weight or lower, even more preferably 1.0% by weight or lower and most preferably 0.8% by weight or lower, based on the solid content of the porous layer.

### Physical Properties of Porous Layer

The air permeability of the porous layer is preferably 100 sec/100 cm³ or lower, more preferably 50 sec/100 cm³ or lower, even more preferably 40 sec/100 cm³ or lower, yet more preferably 30 sec/100 cm³ or lower and most preferably 20 sec/100 cm³ or lower, with a lower limit of preferably 1 sec/100 cm³ or higher and more preferably 5 sec/100 cm³ or higher. If the air permeability of the porous layer is 100 sec/100 cm³ or lower the electrical resistance will be lower, tending to increasing the capacity and cycle characteristic of the nonaqueous electrolyte solution battery. From the same viewpoint, the air permeability per thickness of the porous layer is preferably 30 (sec/100 cm³)/μm or lower, more preferably 25 (sec/100 cm³)/μm or lower, even more preferably 20 (sec/100 cm³)/μm or lower and most preferably 15 (sec/100 cm³)/μm or lower, with a lower limit of preferably 1 (sec/100 cm³)/μm or higher and more preferably 3 (sec/100 cm³)/μm or higher.

The layer density in the porous layer has a lower limit of preferably 0.5 g/(m²·μm) or higher, more preferably 1.0 g/(m²·μm) or higher and even more preferably 1.5 g/(m²·μm) or higher, with an upper limit of preferably 5.0 g/(m²·μm) or lower, more preferably 4.0 g/(m²·μm) or lower and even more preferably 3.0 g/(m²·μm) or lower. The layer density in the porous layer is preferably 0.5 g/(m²·μm) or higher from the viewpoint of inhibiting deformation at temperatures above the melting point of the PO microporous membrane, and preferably 5.0 g/(m²·μm) or lower from the viewpoint of preventing capacity deterioration with repeated cycling, while maintaining the ion permeability of the porous layer.

The 180° peel strength of the porous layer from the multilayer porous membrane or PO microporous membrane is preferably 200 N/m or greater, more preferably 250 N/m or greater, even more preferably 300 N/m or greater, yet more preferably 350 N/m or greater and most preferably 400 N/m or greater. The upper limit for the 180° peel strength is preferably 500 N/m or lower. The “180° peel strength” is the strength when the covering layer has been peeled in a manner so that the surface facing the substrate of the covering layer forms a 180° angle with respect to the substrate. A 180° peel strength within this range will increase the adhesive force with electrodes and inhibit heat shrinkage.

The 90° peel strength of the porous layer from the multilayer porous membrane or PO microporous membrane is preferably 10 N/m or greater, more preferably 15 N/m or greater and even more preferably 20 N/m or greater, from the viewpoint of adhesion with electrodes and inhibiting heat shrinkage. The upper limit for the 90° peel strength is preferably 30 N/m or lower. The “90° peel strength” is the strength when the covering layer has been peeled in a manner so that the surface facing the substrate of the covering layer forms a 90° angle with respect to the substrate.

The upper limit for the mean pore diameter of the porous layer is preferably 0.30 μm or smaller, more preferably 0.20 μm or smaller, even more preferably 0.15 μm or smaller and most preferably 0.10 μm or smaller, with a lower limit of preferably 0.01 μm or larger.

The value for the ratio of: porous layer mean pore diameter/PO microporous membrane gas-liquid pore diameter, is preferably 6.0 or lower, more preferably 5.0 or lower, even more preferably 3.0 or lower and yet more preferably 2.5 or lower.

The moisture content per unit volume of the porous layer can be measured by the method described in the Examples, and it is preferably 5.0 mg/(μm·m²) or lower, more preferably 4.0 mg/(μm·m²) or lower, even more preferably 3.0 mg/(μm·m²) or lower and yet more preferably 2.5 mg/(μm·m²) or lower.

### Polyolefin Microporous Membrane

The porous membrane comprising a polyolefin as the main component (PO microporous membrane) includes a polyolefin, and is preferably composed entirely of the polyolefin. The form of the polyolefin may be a microporous polyolefin, such as a polyolefin membrane, polyolefin fiber fabric (woven fabric) or polyolefin fiber nonwoven fabric. Examples of polyolefins include homopolymers, copolymers or multistage polymers obtained using monomers such as ethylene, propylene, 1-butene, 4-methyl-1-pentene, 1-hexene and 1-octene, any of which polymers may be used alone or in blends of two or more. From the viewpoint of melt viscosity, shutdown property and meltdown property of the PO microporous membrane to be used in the separator, the polyolefin is preferably one or more selected from the group consisting of polyethylene, polypropylene and their copolymers, more preferably it includes polypropylene, and even more preferably it is ethylene-propylene copolymer or a blend of polyethylene and polypropylene.

Specific examples of polyethylene include low-density polyethylene (LDPE), linear low-density polyethylene (LLDPE), medium-density polyethylene (MDPE), high-density polyethylene (HDPE), high molecular weight polyethylene (HMWPE) and ultrahigh molecular weight polyethylene (UHMWPE).

As used herein, “high molecular weight polyethylene” (HMWPE) is polyethylene having a viscosity-average molecular weight (Mv) of 100,000 or greater. Since the Mv of ultrahigh molecular weight polyethylene (UHMWPE) is generally 1,000,000 or greater, the definition of high molecular weight polyethylene (HMWPE) for the purpose of the present specification includes UHMWPE.

Moreover as used herein, “high-density polyethylene” refers to polyethylene having a density of 0.942 to 0.970 g/cm³. The density of polyethylene, for the purpose of the invention, is the value measured according to: D) Density gradient tube method, of JIS K7112(1999).

Specific examples of polypropylene include isotactic polypropylene, syndiotactic polypropylene and atactic polypropylene.

Specific examples of copolymers of ethylene and propylene include ethylene-propylene random copolymers and ethylene-propylene rubber.

When the polyolefin (PO) in the PO microporous membrane includes polyethylene (PE), the PE content is 50% by weight to 100% by weight based on the total mass of the resin component composing the PO microporous membrane, and it is preferably 70% by weight or greater, more preferably 80% by weight or greater, even more preferably 90% by weight or greater and most preferably 93% by weight or greater, from the viewpoint of the fuse characteristic or meltdown property.

When the PO in the PO microporous membrane includes polypropylene (PP), the PP content is greater than 0% by weight and less than 50% by weight based on the total mass of the resin component composing the PO microporous membrane, and from the viewpoint of the melt viscosity and fuse characteristic it is preferably 30% by weight or lower, more preferably 20% by weight or lower, even more preferably 10% by weight or lower and most preferably 7% by weight or lower.

In addition to the polyolefin mentioned above, the PO microporous membrane may further include a resin such as polyethylene terephthalate, or a polycycloolefin, polyethersulfone, polyamide, polyimide, polyimideamide, polyaramid, or polyvinylidene fluoride, nylon or polytetrafluoroethylene.

From the viewpoint of inhibiting high viscosity for the PO resin composition during film formation to reduce generation of defective products, the melt index (MI) of the PO microporous membrane at 190° C. is preferably 0.01 g/10 min or higher and more preferably 0.05 g/10 min or higher, as the lower limit, and preferably 0.70 g/10 min or lower, more preferably 0.60 g/10 min or lower, even more preferably 0.40 g/10 min or lower, especially preferably 0.30 g/10 min or lower and most preferably 0.20 g/10 min or lower, as the upper limit.

The puncture strength in terms of the basis weight (g/m²) of the PO microporous membrane (hereunder referred to as “basis weight-equivalent puncture strength”) is preferably 50 gf/(g/m²) or greater, i.e. 0.49 N/(g/m²) or greater. A PO microporous membrane having a basis weight-equivalent puncture strength of 0.49 N/(g/m²) or greater will generally be resistant to tearing and have increased heat resistance. From the viewpoint of helping to prevent tearing, the basis weight-equivalent puncture strength of the PO microporous membrane is more preferably 0.60 N/(g/m²) or greater, even more preferably 0.70 N/(g/m²) or greater, yet more preferably 0.80 N/(g/m²) or greater, even yet more preferably 0.90 N/(g/m²) or greater and most preferably 1.00 N/(g/m²) or greater. From the viewpoint of improving the safety of the nonaqueous electrolyte solution battery while maintaining the strength of the PO microporous membrane, the basis weight-equivalent puncture strength is more preferably 3.00 N/(g/m²) or lower and even more preferably 2.00 N/(g/m²) or lower.

The puncture strength that is not in terms of the basis weight of the PO microporous membrane (hereunder referred to simply as “puncture strength”) is preferably 100 gf or greater, i.e. 0.98 N or greater, more preferably 1.47 N or greater and even more preferably 1.96 N or greater, from the viewpoint of inhibiting tearing and improving heat resistance, and it is also preferably 9.80 N or lower, more preferably 5.88 N or lower and even more preferably 4.90 N or lower, from the viewpoint of increasing the safety of the nonaqueous electrolyte solution battery while maintaining membrane strength.

The puncture strength or basis weight-equivalent puncture strength can be increased by increasing the orientation of the molecular chains by application of shearing force or stretching of the molded article during extrusion, but since increasing the strength also impairs the thermostability due to higher residual stress, this is controlled as suitable for the purpose.

From the viewpoint of ensuring voltage endurance, the thickness (TB) of the PO microporous membrane is preferably 1.0 μm or larger, more preferably 2.0 μm or larger even more preferably 3.0 μm or larger, yet more preferably 4.0 μm or larger and most preferably 4.5 μm or larger, while from the viewpoint of ensuring capacity for the nonaqueous electrolyte solution battery it is preferably 30.0 μm or smaller, more preferably 20.0 μm or smaller, even more preferably 16.0 μm or smaller, yet more preferably 12.0 μm or smaller, even yet more preferably 9.0 μm or smaller and most preferably 7.0 μm or smaller. The thickness TB of the PO microporous membrane can be adjusted by controlling the die lip gap or the stretch ratio during the stretching step, for example.

From the viewpoint of permeability, the porosity of the PO microporous membrane is preferably 20% or higher, more preferably 30% or higher, even more preferably 35% or higher and most preferably 40% or higher, while from the viewpoint of membrane strength it is preferably 80% or lower, more preferably 70% or lower, even more preferably 60% or lower and most preferably 50% or lower. The porosity of the PO microporous membrane can be adjusted, for example, by controlling the blending ratio of the polyolefin resin composition and the plasticizer, the stretching temperature, the stretch ratio, the heat setting temperature, the stretch ratio during heat setting and the relaxation factor during heat setting, or by controlling any combination of these.

The air permeability of the PO microporous membrane is preferably 10 sec/100 cm³ or greater, more preferably 30 sec/100 cm³ or greater, even more preferably 50 sec/100 cm³ or greater and most preferably 70 sec/100 cm³ or greater, from the viewpoint of avoiding excessive flow of current through the PO microporous membrane between multiple electrodes, while it is also preferably 300 sec/100 cm³ or lower, more preferably 250 sec/100 cm³ or lower, even more preferably 200 sec/100 cm³ or lower, yet more preferably 150 sec/100 cm³ or lower and most preferably 100 sec/100 cm³ or lower, from the viewpoint of permeability.

The viscosity-average molecular weight (Mv) of the PO microporous membrane is preferably 400,000 or greater, more preferably 450,000 or greater and even more preferably 500,000 or greater, as the lower limit, and also preferably 1,300,000 or lower, more preferably 1,200,000 or lower and even more preferably 1,150,000 or lower, as the upper limit. If the Mv of the PO microporous membrane is 400,000 or greater, the melt tension during melt molding will be increased, resulting in satisfactory moldability, while higher membrane strength will also tend to be obtained due to entanglement between the polymers. If the Mv is 1,300,000 or lower, uniform melt kneading of the starting materials will be facilitated and the sheet formability, and especially the thickness stability, will tend to be superior, while holes will tend to be obstructed during temperature increase when the multilayer porous membrane is used as a nonaqueous electrolyte solution battery separator, with such a condition being maintained even at high temperatures to result in a satisfactory fuse function.

The gas-liquid pore diameter of the PO microporous membrane is preferably 30 nm or greater and more preferably 40 nm or greater, and it is also preferably 70 nm or smaller, more preferably 60 nm or smaller and even more preferably 50 nm or smaller. The half-dry pore diameter of the PO microporous membrane is preferably 20 nm or greater and more preferably 30 nm or greater, and is also preferably 60 nm or smaller and more preferably 50 nm or smaller. If the gas-liquid pore diameter and/or half-dry pore diameter of the PO microporous membrane are within the numerical ranges specified above, it will be easier to obtain both ionic conductivity and voltage endurance for the multilayer porous membrane. The pore diameter of the PO microporous membrane can be adjusted, for example, by controlling the polyolefin compositional ratio, the type of polyolefin or plasticizer, and the extruded sheet cooling rate, stretching temperature, stretch ratio, heat setting temperature, stretch ratio during heat setting and relaxation factor during heat setting, or by adjustment of any combination of these.

The PO microporous membrane preferably has low electron conductivity, exhibits ionic conductivity, has high resistance to organic solvents and has fine pore diameters. The PO microporous membrane can be utilized alone as a separator for a lithium ion secondary battery, and in particular it can be suitably used as a separator for a laminar lithium ion secondary battery.

### Thermoplastic Polymer-Containing Layer

At least one side or the outer sides of the multilayer porous membrane according to one embodiment may be provided with a thermoplastic polymer-containing layer if desired. The thermoplastic polymer-containing layer comprises a thermoplastic polymer. The thermoplastic polymer layer may include polymer particles if desired, and/or may also have a dot pattern.

### Thermoplastic Polymer

The thermoplastic polymer is not particularly restricted, and examples include polyolefin resins such as polyethylene, polypropylene and α-polyolefins, fluorine-containing resins such as polyvinylidene fluoride and polytetrafluoroethylene and copolymers comprising them; diene-based polymers having conjugated dienes such as butadiene or isoprene as monomer units, or copolymers and hydrides comprising them; acrylic polymers having acrylic acid esters or methacrylic acid esters as monomer units, or copolymers or hydrides comprising them; rubber compounds such as ethylene-propylene rubber, polyvinyl alcohol and polyvinyl acetate; cellulose derivatives such as ethyl cellulose, methyl cellulose, hydroxyethyl cellulose and carboxymethyl cellulose; and resins having a melting point and/or glass transition temperature of 180° C. or higher, such as polyphenylene ether, polysulfone, polyethersulfone, polyphenylene sulfide, polyetherimide, polyamideimide, polyamide and polyester compounds, as well as their blends. Monomers to be used for synthesis of thermoplastic polymers include monomers having one or more groups selected from the group consisting of hydroxyl, sulfonic acid, carboxyl, amide and cyano groups.

Preferred among these thermoplastic polymers are diene-based polymers, acrylic polymers and fluorine-based polymers, for their superior bindability with electrode active materials and superior strength or flexibility.

### Diene-Based Polymers

Diene-based polymers are not particularly restricted and examples include polymers that contain monomer units obtained by polymerization of conjugated dienes having two conjugated double bonds, such as butadiene or isoprene. Conjugated diene monomers are not particularly restricted, and examples include 1,3-butadiene, isoprene, 2,3-dimethyl-1,3-butadiene, 2-phenyl-1,3-butadiene, 1,3-pentadiene, 2-methyl-1,3-pentadiene, 1,3-hexadiene, 4,5-diethyl-1,3-octadiene and 3-butyl-1,3-octadiene. Any of these may be polymerized alone, or they may be copolymerized.

The proportion of a monomer unit obtained by polymerization of a conjugated diene in the diene-based polymer is not particularly restricted, but it may be 40% by weight or greater, preferably 50% by weight or greater and more preferably 60% by weight or greater of the total diene-based polymer.

The diene-based polymer is not particularly restricted, and examples include homopolymers of conjugated dienes such as polybutadiene or polyisoprene, and copolymers with monomers that are copolymerizable with conjugated dienes. Such a copolymerizable monomer is not particularly restricted, and may be any of the (meth)acrylate monomers or other monomers mentioned below.

Such “other monomers” are not particularly restricted, and examples include α,β-unsaturated nitrile compounds such as acrylonitrile and methacrylonitrile; unsaturated carboxylic acids such as acrylic acid, methacrylic acid, itaconic acid and fumaric acid; styrene-based monomers such as styrene, chlorostyrene, vinyltoluene, t-butylstyrene, vinylbenzoic acid, methyl vinylbenzoate, vinylnaphthalene, chloromethylstyrene, hydroxymethylstyrene, α-methylstyrene and divinylbenzene; olefins such as ethylene and propylene; halogen atom-containing monomers such as vinyl chloride and vinylidene chloride; vinyl esters such as vinyl acetate, vinyl propionate, vinyl butyrate and vinyl benzoate; vinyl ethers such as methyl vinyl ether, ethyl vinyl ether and butyl vinyl ether; vinyl ketones such as methyl vinyl ketone, ethyl vinyl ketone, butyl vinyl ketone, hexyl vinyl ketone and isopropenyl vinyl ketone; heterocyclic ring-containing vinyl compounds such as N-vinylpyrrolidone, vinylpyridine and vinylimidazole; acrylic acid ester and/or methacrylic acid ester compounds such as methyl acrylate and methyl methacrylate; hydroxyalkyl group-containing compounds such as β-hydroxyethyl acrylate and β-hydroxyethyl methacrylate; and amide-based monomers such as acrylamide, N-methylolacrylamide and acrylamide-2-methylpropanesulfonic acid, any of which may be used alone or in combinations of two or more.

### Acrylic Polymers

Acrylic polymers are not particularly restricted but are preferably polymers including a monomer unit obtained by polymerization of a (meth)acrylate monomer. When the thermoplastic polymer-containing layer contains an acrylic polymer as a thermoplastic polymer, it preferably contains a copolymer with a (meth)acrylic acid ester monomer unit. It is preferred for the thermoplastic polymer of the thermoplastic polymer-containing layer to include a copolymer with a (meth)acrylic acid ester monomer unit because the adhesive force will be improved when the multilayer porous membrane or separator has a low basis weight.

(Meth)acrylate monomers are not particularly restricted, and examples include alkyl (meth)acrylates such as methyl (meth)acrylate, ethyl (meth)acrylate, n-propyl (meth)acrylate, isopropyl (meth)acrylate, n-butyl (meth)acrylate, t-butyl (meth)acrylate, pentyl (meth)acrylate, hexyl (meth)acrylate, heptyl (meth)acrylate, octyl (meth)acrylate, 2-ethylhexyl (meth)acrylate, nonyl (meth)acrylate, decyl (meth)acrylate, lauryl (meth)acrylate, n-tetradecyl (meth)acrylate and stearyl (meth)acrylate; hydroxyl group-containing (meth)acrylates such as hydroxyethyl (meth)acrylate, hydroxypropyl (meth)acrylate and hydroxybutyl (meth)acrylate; amino group-containing (meth)acrylates such as aminoethyl (meth)acrylate; and epoxy group-containing (meth)acrylates such as glycidyl (meth)acrylate (GMA).

The proportion of a monomer unit obtained by polymerization of a (meth)acrylate monomer is not particularly restricted, but it may be, for example, 40% by weight or greater, preferably 50% by weight or greater and more preferably 60% by weight or greater of the total acrylic polymer. Acrylic polymers include homopolymers of (meth)acrylate monomers, and copolymers with monomers that are copolymerizable with them.

Such copolymerizable monomers include the “other monomers” mentioned above for diene-based polymers, any of which may be used alone or in combinations of two or more.

### Fluorine-Based Polymer

Fluorine-based polymers are not particularly restricted, and examples include vinylidene fluoride homopolymers, and copolymers of monomers that are copolymerizable with them. Fluorine-based polymers are preferred from the viewpoint of electrochemical stability.

The proportion of a monomer unit obtained by polymerization of vinylidene fluoride is not particularly restricted, and it may be, for example, 40% by weight or greater, preferably 50% by weight or greater and more preferably 60% by weight or greater.

Monomers that are copolymerizable with vinylidene fluoride are not particularly restricted, and examples include fluorine-containing ethylenically unsaturated compounds such as vinyl fluoride, tetrafluoroethylene, trifluorochloroethylene, hexafluoropropylene, hexafluoroisobutylene, perfluoroacrylic acid, perfluoromethacrylic acid, and fluoroalkyl esters of acrylic acid or methacrylic acid; non-fluorinated ethylenically unsaturated compounds such as cyclohexyl vinyl ether and hydroxyethyl vinyl ether; and non-fluorinated diene compounds such as butadiene, isoprene and chloroprene.

Preferred among these fluorine-based polymers are homopolymers of vinylidene fluoride, vinylidene fluoride/tetrafluoroethylene copolymer and vinylidene fluoride/tetrafluoroethylene/hexafluoropropylene copolymer. Particularly preferred fluorine-based polymers are vinylidene fluoride/tetrafluoroethylene/hexafluoropropylene copolymers, with the monomer composition usually being 30% by weight to 90% by weight vinylidene fluoride, 9% by weight to 50% by weight tetrafluoroethylene and 1% by weight to 20% by weight hexafluoropropylene. Particles of such fluorine resins may be used alone or in combinations of two or more different types.

Monomers to be used for synthesis of thermoplastic polymers include monomers with hydroxyl, carboxyl, amino, sulfonic acid, amide or cyano groups.

Monomers with hydroxyl groups are not particularly restricted, and may be vinyl-based monomers, such as pentenol.

Monomers with carboxyl groups are also not particularly restricted, and examples include vinyl-based monomers such as unsaturated carboxylic acids or pentenoic acids having ethylenic double bonds, such as (meth)acrylic acid or itaconic acid.

Monomers with amino groups are not particularly restricted and include 2-aminoethyl methacrylate, for example.

Monomers with sulfonic acid groups are not particularly restricted, and examples include vinylsulfonic acid, methylvinylsulfonic acid, (meth)allylsulfonic acid, styrenesulfonic acid, ethyl (meth)acrylate-2-sulfonate, 2-acrylamide-2-methylpropanesulfonic acid and 3-allyloxy-2-hydroxypropanesulfonic acid.

Monomers with amide groups are not particularly restricted, and examples include acrylamide (AM), methacrylamide, N-methylolacrylamide and N-methylolmethacrylamide.

Monomers with cyano groups are not particularly restricted, and examples include acrylonitrile (AN), methacrylonitrile, α-chloroacrylonitrile and α-cyanoethyl acrylate.

The thermoplastic polymer may be one polymer alone or a blend of two or more polymers, but it preferably includes two or more different polymers. The thermoplastic polymer may also be used together with a solvent, the solvent being one that can uniformly and stably disperse the thermoplastic polymer, such as N-methylpyrrolidone, N,N-dimethylformamide, N,N-dimethylacetamide, water, ethanol, toluene, hot xylene, methylene chloride or hexane, with aqueous solvents being preferred among these. The thermoplastic polymer may also be used in the form of a latex.

### Glass Transition Temperature of Thermoplastic Polymer

From the viewpoint of bindability with the substrate and preventing blocking, as well as exhibiting adhesive force between the separator and electrodes, while also ensuring proper distance between the electrodes and separator in the nonaqueous electrolyte solution battery and shortening the electrolyte solution injection time, the thermoplastic polymer composing the thermoplastic polymer-containing layer preferably has thermal properties with at least two glass transition temperatures, at least one of the glass transition temperatures being in the range of 20° C. or lower, and at least one of the glass transition temperatures being in the range of 30° C. to 120° C.

The glass transition temperature is determined from a DSC curve obtained by differential scanning calorimetry (DSC). The glass transition temperature may also be referred to herein as “Tg”.

Specifically, it is determined by the intersection between a straight line extending the low-temperature end baseline in the DSC curve toward the high-temperature end, and the tangent line at the inflection point in the stepwise change region of glass transition. More specifically, it may be determined with reference to the method described in the Examples.

The term “glass transition” refers to when a change in heat quantity accompanying the change in state of a polymer test piece in DSC occurs at the endothermic end. Such a change in heat quantity is observed as a stepwise change in the DSC curve, or a combination of a stepwise change and a peak.

A “stepwise change” is a portion of the DSC curve that moves away from the previous baseline and toward a new baseline, and this also includes any combination of a peak and stepwise change.

The “inflection point” is the point at which the slope of the DSC curve is maximum in the stepwise change region. In the stepwise change region, this represents the point where the upwardly convex curve changes to a downwardly convex curve.

The term “peak” refers to a portion of the DSC curve that moves away from the baseline and then returns to the same baseline.

The term “baseline” refers to the DSC curve in the temperature zone where no transition or reaction takes place in the test piece.

If at least one glass transition temperature of the thermoplastic polymer used for the embodiment is in the range of 20° C. or lower, the adhesiveness for the microporous membrane will be superior and blocking will be reduced, resulting in an effect of excellent adhesiveness between the separator and electrodes. The glass transition temperature is preferably −100° C. or higher, more preferably −50° C. or higher, even more preferably −40° C. or higher and especially preferably −6° C. or higher, from the viewpoint of the handling property and blocking resistance, and is also preferably 20° C. or lower, more preferably 10° C. or lower and especially preferably 0° C. or lower, from the viewpoint of adhesiveness with the microporous membrane.

If at least one glass transition temperature of the thermoplastic polymer used for the embodiment is in the range of 30° C. to 120° C., adhesion between the separator and electrodes, as well as handleability, will be excellent, and it will be possible to maintain distance between the electrode surface and the separator substrate surface in the nonaqueous electrolyte solution battery, while also shortening the electrolyte solution injection time. The glass transition temperature is preferably −30° C. or higher, more preferably −40° C. or higher, even more preferably −70° C. or higher and especially preferably −95° C. or higher, from the viewpoint of the handling property and blocking resistance, and it is also preferably 150° C. or lower, more preferably 130° C. or lower and especially preferably 120° C. or lower, from the viewpoint of adhesive force.

A thermoplastic polymer with two glass transition temperatures can be obtained, for example, by a method of blending two or more thermoplastic polymers, without any limitation to this method.

For a polymer blend, the glass transition temperature of the thermoplastic polymer as a whole can be controlled by combination of a polymer with a high glass transition temperature and a polymer with a low glass transition temperature. Multiple functions can also be imparted to the thermoplastic polymer as a whole. In the case of a blend, for example, both stickiness resistance and wettability with the polyolefin microporous membrane can be obtained with a blend of two or more different types of polymers having a glass transition temperature in the range of 30° C. or higher, and a polymer having a glass transition temperature in the range of 20° C. or lower. The blending ratio, in the case of a blend, is preferably in the range of 0.1:99.9 to 99.9:0.1, more preferably 5:95 to 95:5, even more preferably 50:50 to 95:5 and yet more preferably 60:40 to 90:10, as the ratio of polymers having a glass transition temperature in the range of 30° C. or higher and polymers having a glass transition temperature in the range of 20° C. or lower. The viscoelasticity can be controlled by combination of a polymer with high viscosity and a polymer with high elasticity.

For one embodiment, the glass transition temperature (Tg) of the thermoplastic polymer can be appropriately adjusted by changing the monomer components used for production of the thermoplastic polymer and the loading proportion of each monomer, for example. Specifically, the Tg for each monomer used for production of the thermoplastic polymer can be estimated from the known Tg for its homopolymer (as listed in “Polymer Handbook (a Wiley-Interscience Publication), for example), and the blending ratio of the monomer. For example, a high Tg can be obtained with a copolymer comprising a blend with a high proportion of monomers such as styrene, methyl methacrylate and acrylonitrile, which form a polymer with a Tg of about 100° C., or a low Tg can be obtained with a copolymer comprising a blend of monomers such as butadiene which forms a polymer with a Tg of about −80° C., or n-butyl acrylate and 2-ethylhexyl acrylate which form a polymer with a Tg of about −50° C.

The Tg of the polymer can be approximated by the Fox formula (formula (1) below). The glass transition point of the thermoplastic polymer of the present application is the value measured by the method using DSC described above.

$$1 / Tg = {W}_{1} / {Tg}_{1} + {W}_{2} / {Tg}_{2} + … + {W}_{i} / {Tg}_{i} + … {W}_{n} / {Tg}_{n} \qquad ( 1 )$$

{In formula (1), Tg (K) represents the Tg of the copolymer, Tgᵢ (K) represents Tg for a homopolymer of each monomer i, and Wᵢ represents the mass fraction of each monomer.}

### Structure of Thermoplastic Polymer-Containing Layer

In the thermoplastic polymer-containing layer, preferably a thermoplastic resin having a glass transition temperature of 30° C. to 120° C. is present on the outer surface side of the multilayer porous membrane, and a thermoplastic resin having a glass transition temperature of 20° C. or lower is present on the interface side between the polyolefin microporous membrane and the thermoplastic polymer-containing layer. The “outer surface” is the side of the thermoplastic polymer-containing layer that contacts with an electrode when the multilayer porous membrane or separator and the electrode are stacked. The “interface” is the side of the thermoplastic polymer-containing layer that contacts with the polyolefin microporous membrane or porous layer.

If a thermoplastic polymer having a glass transition temperature of 30° C. to 120° C. is present in the thermoplastic polymer-containing layer on the outer surface side of the multilayer porous membrane, the adhesiveness with the microporous membrane will be superior, and adhesiveness between the separator and electrodes will tend to be superior as a result. If a thermoplastic polymer having a glass transition temperature of 20° C. or lower is present on the interface side between the polyolefin microporous membrane and the thermoplastic polymer-containing layer, adhesion between the separator and electrodes, as well as handleability, will both tend to be superior. A separator having a thermoplastic polymer-containing layer as described above will tend to have further improved handleability and adhesion between the separator and electrodes.

Such a structure may be one in which the thermoplastic polymer (a) is composed of thermoplastic polymer particles and a binder resin that binds the thermoplastic polymer particles to the polyolefin microporous membrane with the thermoplastic polymer particles exposed on the surface. The glass transition temperature of the thermoplastic polymer particles is in the range of 30° C. to 120° C. A thermoplastic polymer having a glass transition temperature of 20° C. or lower is present on the interface side between the polyolefin microporous membrane and the thermoplastic polymer-containing layer, or alternatively, the thermoplastic polymer (b) has a layered structure, the glass transition temperature of the thermoplastic polymer in the uppermost surface layer (when used as a separator) being in the range of 30° C. to 120° C., and a thermoplastic polymer having a glass transition temperature of 20° C. or lower being present on the interface side between the polyolefin microporous membrane and the thermoplastic polymer-containing layer. The thermoplastic polymer (b) may also have a layered structure of polymers with different Tg values.

### Mean Particle Size of Thermoplastic Polymer

The structure of the thermoplastic polymer is not particularly restricted and may be particulate, for example. Such a structure will tend to provide more excellent adhesion between the separator and electrodes and handleability for the separator. The term “particulate” as used herein means that in measurement with a scanning electron microscope (SEM), the individual thermoplastic polymers have borders with shapes such as thin elongated, spherical or polygonal shapes.

The particle size distribution and median diameter of the thermoplastic polymer particles can be measured using a laser particle size distribution analyzer (MT3300EX Microtrac by Nikkiso Co., Ltd.). When necessary, the particle size distribution of the water or binder polymer can be used as the baseline for adjustment of the particle size distribution of the thermoplastic polymer particles. The particle size with a cumulative frequency of 50% is represented as D₅₀, and the D₅₀ of the thermoplastic polymer particles is represented as D_{P}.

The mean particle size D_{P} of the thermoplastic polymer particles is preferably 100 nm or larger, more preferably 130 nm or larger, even more preferably 320 nm or larger and most preferably 400 nm or larger, and/or preferably 1000 nm or smaller, more preferably 700 nm or smaller, even more preferably 590 nm or smaller and most preferably 550 nm or smaller, from the viewpoint of exhibiting adhesive force between the separator and electrodes while maintaining distance between multiple electrodes across the separator, and shortening the injection time for the electrolyte solution into a nonaqueous electrolyte solution battery provided with the separator.

### Basis Weight of Thermoplastic Polymer-Containing Layer Per Side

In the separator of one embodiment, the basis weight per side of the thermoplastic polymer-containing layer is preferably 0.03 g/m² or greater, more preferably 0.04 g/m² or greater and even more preferably 0.06 g/m² or greater, and also 0.3 g/m² or lower, more preferably 0.15 g/m² or lower and especially preferably 0.10 g/m² or lower, from the viewpoint of adhesive force. The basis weight of the thermoplastic polymer-containing layer can be adjusted by changing the polymer concentration of the coating solution or the coating amount of the polymer solution. The preferred range for the basis weight per side of the thermoplastic polymer-containing layer is greater than 0.08 g/m², so long as the effect of the embodiment is not impeded, from the viewpoint of preventing deformation of the battery shape with expansion and contraction of the electrodes and obtaining a satisfactory cycle characteristic for the battery.

### Thermoplastic Polymer-Containing Layer Form and Coating Percentage of Substrate Surface by Thermoplastic Polymer-Containing Layer

The form (pattern) in which the thermoplastic polymer-containing layer is present may be mutual dispersion of the thermoplastic polymer, or a sea-island pattern, across the entire surface of the multilayer porous membrane. When the thermoplastic polymer is present in a sea-island form, the arrangement pattern may be dotted, striped, lattice-like, banded, hexagonal or random, or a combination thereof. The thermoplastic polymer-containing layer preferably has a dot pattern.

The dots are portions including the thermoplastic polymer and portions lacking the thermoplastic polymer on the polyolefin microporous membrane, the portions including the thermoplastic polymer being present as islands. The thermoplastic polymer-containing portions of the thermoplastic polymer-containing layer may also be independent.

The dot diameter of the thermoplastic polymer-containing layer is preferably 20 μm or larger, more preferably 30 μm or larger and even more preferably 40 μm or larger, and also preferably 1,200 μm or smaller, more preferably 1,100 μm or smaller, even more preferably 1,000 μm or smaller, yet more preferably 500 μm or smaller and especially preferably 300 μm, from the viewpoint of adhesion with the PO microporous membrane or electrodes, improved strength of the multilayer porous membrane, or inhibiting air permeability increase for the PO microporous membrane.

The distance between dots in the thermoplastic polymer-containing layer is preferably 100 μm or greater, more preferably 120 μm or greater and even more preferably 140 μm or greater, and also preferably 3,500 μm or less, more preferably 3,300 μm or less and even more preferably 3,000 μm or less, from the viewpoint of adhesion with the PO microporous membrane or electrodes, improved strength of the multilayer porous membrane, or reduced air permeability increase with respect to the PO microporous membrane.

The adhesive force of the thermoplastic polymer-containing layer with the electrodes is preferably 0.5 N/m to 50 N/m as the Dry adhesive force and 0.5 N/m to 50 N/m as the Wet adhesive force. The thermoplastic polymer-containing layer more preferably has adhesive force within the numerical ranges specified above when facing the side of an electrode material that can generally be used as a negative electrode.

According to one embodiment, the total coverage area ratio of the thermoplastic polymer-containing layer on the substrate surface is preferably 3% or higher, 4% or higher, 5% or higher, 10% or higher, 20% or higher, 30% or higher or 40% or higher, and preferably 90% or lower, 80% or lower, 75% or lower or 70% or lower, from the viewpoint of maintaining adhesive force of the multilayer porous membrane or separator with the electrodes while lowering the battery resistance. A small area coverage of the thermoplastic polymer-containing layer will result in an uneven current distribution due to non-uniform distance between the separator and the electrode interface, thereby tending to produce a temperature increase in (heat) safety testing. A large area coverage of the thermoplastic polymer-containing layer will increase the battery resistance and produce poorer results in rate testing. The total coverage area ratio S of the thermoplastic polymer-containing layer in the substrate surface is calculated by the following formula.

S (%)=Total area coverage of thermoplastic polymer-containing layer÷surface area of substrate×100

The total coverage area ratio (%) of the coating pattern of the thermoplastic polymer-containing layer on the substrate surface is measured using a microscope (model: VHX-7000 by Keyence Corp.). A sample separator is photographed at 30-fold magnification (coaxial illumination), and then automatic area measurement is selected as the measuring mode for measurement of the total coverage area ratio of the thermoplastic polymer. The coverage area ratio for each sample is the arithmetic mean for three measurements.

The form or total coverage area ratio of the thermoplastic polymer-containing layer can be adjusted by changing the polymer concentration of the coated solution or the coating amount, coating method and coating conditions for the polymer solution.

### Properties of Multilayer Porous Membrane

The air permeability of the multilayer porous membrane is 300 sec/100 cm³ or lower from the viewpoint of obtaining an optimized, thin, highly heat-resistant and low-electrical-resistance porous layer, as well as the viewpoint of the energy density, capacity and output/cycle characteristics of the nonaqueous electrolyte solution battery comprising the multilayer porous membrane as the separator. The air permeability is preferably 200 sec/100 cm³ or lower, more preferably 200 sec/100 cm³ or lower, even more preferably 150 sec/100 cm³ or lower and most preferably 100 sec/100 cm³ or lower, from the viewpoint of ion permeability and from the viewpoint of further reducing resistance to further improve the battery capacity and cycle characteristic. The air permeability of the multilayer porous membrane is also preferably 10 sec/100 cm³ or higher from the viewpoint of ensuring greater safety for the nonaqueous electrolyte solution battery so that current does not flow excessively between the electrodes through the multilayer porous membrane.

The heat shrinkage factor of the multilayer porous membrane after it has been allowed to stand for 1 hour in an atmosphere with a temperature of 150° C. (the “150° C. heat shrinkage factor”), is preferably 10% or lower, more preferably 5% or lower, even more preferably 2% or lower and especially preferably 1% or lower, as the upper limit, and preferably 0% or higher as the lower limit, in both the MD and TD. A multilayer porous membrane having a 150° C. heat shrinkage factor of 10% or lower will allow the separator to have reduced thickness and high heat resistance, thus not only contributing to improved productivity, but also contributing to improved energy density and safety when incorporated as a thin-film separator into a nonaqueous electrolyte solution battery. Measurement and calculation of the 150° C. heat shrinkage factor may be made, in both the MD and TD, either under Dry conditions after allowing the multilayer porous membrane to stand for 1 hour in an oven, or under Wet conditions after immersing the multilayer porous membrane in a nonaqueous solvent such as propylene carbonate or a nonaqueous electrolyte solution containing it, and then allowing it to stand for 1 hour in an oven.

The heat shrinkage factor of the multilayer porous membrane at 130° C. (the “130° C. heat shrinkage factor”) is preferably 10% or lower and more preferably 5% or lower, as the upper limit, and preferably 0% or higher as the lower limit, in both the MD and TD. The 130° C. heat shrinkage factor is preferably 10% or lower in both the MD and TD from the viewpoint of preventing rupture of the multilayer porous membrane and inhibiting short circuiting, which can occur due to battery abnormalities. Measurement and calculation of the 130° C. heat shrinkage factor may be made, in both the MD and TD, under Dry conditions after allowing the multilayer porous membrane to stand for 1 hour in an oven.

For high peel strength and a low water content, as well as heat resistance, the multilayer porous membrane preferably comprises the water-insoluble polymer binder described above. The position of the water-insoluble polymer binder in the multilayer porous membrane is not particularly restricted, and for example, the water-insoluble polymer binder may be located either inside or outside of the porous layer.

In order to ensure voltage endurance, the total thickness of the multilayer porous membrane is preferably 1 μm or greater, more preferably 3 μm or greater and even more preferably 5 μm or greater. The total thickness of the multilayer porous membrane is also preferably 30.0 μm or smaller to help prevent impairment of the capacity of the nonaqueous electrolyte solution battery in which the multilayer porous membrane is mounted, and it is more preferably 25 μm or smaller, even more preferably 20 μm or smaller and especially preferably 15 μm or smaller.

For the multilayer porous membrane of the embodiment, the ratio (T/TB) of the thickness (T) of the porous layer and the thickness (TB) of the PO microporous membrane is preferably 0.05 or higher and/or preferably 0.35 or lower. A multilayer porous membrane having a thickness ratio (T/TB) within this numerical range will allow the separator to have reduced thickness, thus not only contributing to improved productivity, but also contributing to improved energy density and safety when incorporated as a thin-film separator into a nonaqueous electrolyte solution battery. Measurement and calculation of the thickness ratio (T/TB) may be for one or both sides of the PO microporous membrane, but from the viewpoint of the action mechanism of the invention, and the principle of thickness measurement, the measurement and calculation are preferably carried out on both sides of the PO microporous membrane, and specifically with T as the total thickness of the porous layer disposed on the multilayer porous membrane.

In the multilayer porous membrane, the ratio of the air permeability of the porous layer with respect to the air permeability of the polyolefin microporous membrane (multilayer porous membrane air permeability increase ratio) is preferably such that it does not impair the air permeability of the polyolefin microporous membrane, and it is more preferably 0.01 or higher, from the viewpoint of ion permeability and the viewpoint of reducing resistance to improve the capacity and cycle characteristic of the nonaqueous electrolyte solution battery, while it is also preferably 0.40 or lower, more preferably 0.30 or lower and even more preferably 0.20 or lower, from the viewpoint of avoiding excessive flow of current between electrodes through the multilayer porous membrane, to ensure safety of the nonaqueous electrolyte solution battery.

The puncture strength of the multilayer porous membrane is preferably 0.98 N or greater, more preferably 1.47 N or greater and even more preferably 1.96 N or greater, as the lower limit, and preferably 9.81 N or lower, more preferably 5.88 N or lower and even more preferably 4.90 N or lower, as the upper limit, from the viewpoint of inhibiting tearing and of improving the safety of the nonaqueous electrolyte solution battery while maintaining membrane strength.

The ratio of the light transmittance of the multilayer porous membrane at 550 nm and the light transmittance of the PO microporous membrane at 550 nm in the multilayer porous membrane of the embodiment is preferably 0.4 or higher and lower than 1.0. With this level of optical transparency for the multilayer porous membrane of the embodiment, extraneous material or unmelted material inside or on the surface of the substrate will tend to be more easily verifiable after the porous layer has been disposed on the PO microporous membrane.

The light transmittance of the multilayer porous membrane at a wavelength of 550 nm is preferably 4.0% or greater from the viewpoint of maintaining optical transparency, and it is preferably lower than 10.0% from the viewpoint of maintaining the ability to accurately detect coating loss of the PO microporous membrane. A white LED is usually used as the light source for inspection of a nonaqueous electrolyte solution battery separator, and the wavelength of 550 nm is near the center wavelength in the white LED wavelength range.

### Method for Producing Multilayer Porous Membrane

The multilayer porous membrane of the embodiment can be produced by a known method, and as an example, it can be produced by first forming the PO microporous membrane and then disposing the porous layer on at least one side of the PO microporous membrane.

If desired, the multilayer porous membrane can be produced by first forming the PO microporous membrane, and then disposing the first porous layer on one side of the PO microporous membrane and disposing the second porous layer on the other side of the PO microporous membrane. Alternatively, the PO microporous membrane and porous layer may be produced by co-extrusion, or the first porous layer and second porous layer may each be extruded onto both sides of the PO microporous membrane, or the separately produced PO microporous membrane and porous layer may be bonded together.

The method for producing a multilayer porous membrane may also include, if desired, a step of disposing a porous layer on at least one side of the PO microporous membrane to obtain a multilayer porous membrane, and forming a thermoplastic polymer-containing layer on at least one side of the obtained multilayer porous membrane.

### Method for Producing Polyolefin Microporous Membrane

The method for producing the polyolefin microporous membrane (PO microporous membrane) is not particularly restricted, and any known production method may be employed.

Methods for producing polyolefin microporous membranes are largely divided into wet methods and dry methods. In a wet method, extractable matter is added to and dispersed in a polyolefin and the dispersion is cast, after which the extractable matter is extracted using a liquid such as a solvent to form pores. Examples of dry methods include (a) a method in which an unstretched body is formed which has formed a crystal lamellar structure during melt extrusion casting, and pores are then formed by lamellar cleavage primarily by uniaxial stretching, and (b) a method in which incompatible particles such as inorganic particles are added to a polyolefin and the mixture is stretched in order to detach the interfaces between the different types of materials and form pores.

Examples of methods for producing a PO microporous membrane for the embodiment include:
(1) a method of melt kneading a polyolefin resin composition and a pore-forming material and molding the mixture into a sheet, with stretching if necessary, and then extracting the pore-forming material to form pores,
(2) a method of melt kneading a polyolefin resin composition, extruding it at a high draw ratio, and then stretching it with heat treatment to detach the polyolefin crystal interface and form pores,
(3) a method of melt kneading a polyolefin resin composition and an inorganic filler and casting the mixture onto a sheet, and then detaching the interface between the polyolefin and the inorganic filler by stretching to form pores, and
(4) a method of first dissolving the polyolefin resin composition, and then dipping it in a poor solvent for the polyolefin to solidify the polyolefin while simultaneously removing the solvent, to form pores.

An example of a method of producing the PO microporous membrane will now be described, as a method of melt kneading a polyolefin resin composition and a pore-forming material, casting the mixture into a sheet, and then extracting the pore-forming material.

First, the polyolefin resin composition and the pore-forming material are melt kneaded. During the melt kneading, a polyolefin resin, with other additives as necessary, may be loaded into a resin kneader such as an extruder, feeder, Laboplastomil, kneading roll or Banbury mixer, and the pore-forming material may then be introduced at a desired proportion and kneaded in while hot melting the resin components.

The pore-forming material may be a plasticizer, an inorganic material, or a combination thereof. The plasticizer is not particularly restricted, and may be a non-volatile solvent that can form a homogeneous solution at above the melting point of the polyolefin. For example, it may be a hydrocarbon such as liquid paraffin or paraffin wax; an ester such as dioctyl phthalate or dibutyl phthalate; or a higher alcohol such as oleyl alcohol or stearyl alcohol. Liquid paraffins are preferred among these plasticizers because of their high compatibility when the polyolefin resin is polyethylene and/or polypropylene, and low risk of interfacial peeling between the resin and plasticizer even when the melt kneaded mixture is stretched, thereby facilitating homogeneous stretching. Examples of inorganic materials include, but are not particularly limited to, oxide-based ceramics such as alumina, silica (silicon oxide), titania, zirconia, magnesia, ceria, yttria, zinc oxide and iron oxide; nitride-based ceramics such as silicon nitride, titanium nitride and boron nitride; ceramics such as silicon carbide, calcium carbonate, aluminum sulfate, aluminum hydroxide, potassium titanate, talc, kaolin clay, kaolinite, halloysite, pyrophyllite, montmorillonite, sericite, mica, amesite, bentonite, asbestos, zeolite, calcium silicate, magnesium silicate, diatomaceous earth and quartz sand; and glass fibers. These may be used alone or as combinations of two or more types. Of these inorganic materials, silica, alumina and titania are preferred from the viewpoint of electrochemical stability, and silica is especially preferred from the viewpoint of easier extraction.

The melt kneaded mixture is then cast into a sheet. The method of producing the cast sheet may be, for example, a method of extruding the melt kneaded mixture through a T-die or the like into a sheet, and contacting it with a heat conductor to cool it to a sufficiently lower temperature than the crystallization temperature of the resin component, thereby solidifying it. The heat conductor used for cooling solidification may be a metal, water, air or a plasticizer. Metal rolls are preferably used for high heat conduction efficiency. When the extruded kneaded blend is to be contacted with metal rolls, it is more preferably sandwiched between the rolls because this will further increase the heat conduction efficiency while causing the sheet to become oriented and increasing the membrane strength, and also tending to improve the surface smoothness of the sheet. The die lip gap when extruding the melt kneaded mixture into a sheet from a T-die is preferably 200 μm or larger and more preferably 500 μm or larger, and preferably 3,000 μm or smaller and more preferably 2,500 μm or smaller. Limiting the die lip gap to 200 μm or larger can reduce tip adhesion, can lower the effects of streaks and defects on the film quality, and can lower the risk of film rupture during the subsequent stretching step. Limiting the die lip gap to 3,000 μm or smaller, on the other hand, can speed the cooling rate to prevent cooling irregularities while maintaining sheet thickness stability.

The cast sheet may also be rolled. Rolling may be carried out, for example, by a press method using a double belt press machine or the like. Rolling can increase the orientation of the surface layer sections, in particular. The area increase produced by rolling is preferably by a factor of greater than 1, and 3 or lower, and more preferably a factor of greater than 1, and 2 or lower. If the rolling factor exceeds 1, the plane orientation will increase and the membrane strength of the final porous membrane will tend to increase. If the rolling factor is 3 or lower, there will be less of a difference in orientation between the surface layer portion and the center interior portion, tending to allow formation of a porous structure that is more uniform in the membrane thickness direction.

The pore-forming material is then removed from the cast sheet to obtain a porous membrane. The method of removing the pore-forming material may be, for example, a method of immersing the cast sheet in an extraction solvent to extract the pore-forming material, and then thoroughly drying it. The method of extracting the pore-forming material may be either a batch process or a continuous process. In order to minimize shrinkage of the porous membrane, it is preferred to constrain the edges of the cast sheet during the series of steps of immersion and drying. The residue of the pore-forming material in the porous membrane is preferably less than 1% by weight of the total mass of the porous membrane.

The extraction solvent used for extraction of the pore-forming material is preferably a poor solvent for the polyolefin resin and a good solvent for the pore-forming material, and one having a boiling point that is lower than the melting point of the polyolefin resin. Examples of such extraction solvents include hydrocarbons such as n-hexane and cyclohexane; halogenated hydrocarbons such as methylene chloride and 1,1,1-trichloroethane; non-chlorine-based halogenated solvents such as hydrofluoroethers and hydrofluorocarbons; alcohols such as ethanol and isopropanol; ethers such as diethyl ether and tetrahydrofuran; and ketones such as acetone and methyl ethyl ketone. These extraction solvents may be collected by a process such as distillation and then reutilized. When an inorganic material is used as the pore-forming material, an aqueous solution of sodium hydroxide or potassium hydroxide may be used as the extraction solvent.

The cast sheet or porous membrane is preferably also stretched, with the stretching optionally being carried out before extraction of the pore-forming material from the cast sheet. The stretching may also be carried out on the porous membrane after the pore-forming material has been extracted from the cast sheet, or alternatively both before and after extraction of the pore-forming material from the cast sheet.

Either uniaxial stretching or biaxial stretching can be suitably used for the stretching treatment, but biaxial stretching is preferred from the viewpoint of improving the strength of the obtained PO microporous membrane. When a cast sheet is subjected to high-ratio stretching in the biaxial directions, the molecules become oriented in the in-plane direction, so that the microporous membrane that is obtained as the final result is less likely to tear and has high puncture strength.

Examples of stretching methods include simultaneous biaxial stretching, sequential biaxial stretching, multistage stretching and repeated stretching. Simultaneous biaxial stretching is preferred from the viewpoint of increasing the puncture strength and obtaining greater uniformity during stretching and superior shutdown properties. Successive biaxial stretching is preferred from the viewpoint of facilitating control of the planar orientation.

Simultaneous biaxial stretching is a stretching method in which stretching in the MD and stretching in the TD are carried out simultaneously, and in such a case the stretch ratios in each direction may be different. Sequential biaxial stretching is a stretching method in which stretching in the MD and TD are carried out independently, in such a manner that when MD or TD stretching is being carried out, the other direction is in a non-constrained state or in an anchored state with fixed length.

The stretch ratio is preferably at least 20-fold and more preferably at least 25-fold as the area increase, and preferably 100-fold or less and more preferably 70-fold or less as the area increase. The stretch ratio in each axial direction is preferably at least 4-fold in the MD and at least 4-fold in the TD, more preferably at least 5-fold in the MD and at least 5-fold in the TD, and also preferably 10-fold or less in the MD and 10-fold or less in the TD, and more preferably 8-fold or less in the MD and 8-fold or less in the TD. If the total area factor is 20 or greater the obtained PO microporous membrane will tend to be imparted with sufficient strength, and if the total area factor is 100 or lower, membrane rupture will tend to be prevented in the stretching step, resulting in high productivity.

In order to help prevent shrinkage of the PO microporous membrane, heat treatment for heat setting may be carried out either after the stretching step or after formation of the PO microporous membrane. The PO microporous membrane may also be subjected to post-treatment such as hydrophilicizing treatment with a surfactant, or crosslinking treatment with ionizing radiation.

From the viewpoint of inhibiting shrinkage, the PO microporous membrane is preferably subjected to heat treatment for heat setting. The method of heat treatment may include a stretching procedure carried out with a predetermined temperature atmosphere and a predetermined stretch ratio to adjust the physical properties, and/or a relaxation procedure with a predetermined temperature atmosphere and a predetermined relaxation factor to reduce the stretching stress. The relaxation procedure may also be carried out after the stretching procedure. Such heat treatment can be carried out using a tenter or roll stretcher.

From the viewpoint of obtaining a PO microporous membrane with higher strength and higher porosity, the stretching procedure is preferably stretching to a factor of 1.1 or greater and more preferably to a factor of 1.2 or greater in the MD and/or TD of the membrane.

The relaxation procedure is contraction in the MD and/or TD of the membrane. The relaxation factor is the value of the dimension of the membrane after relaxation divided by the dimension of the membrane before the relaxation. When relaxation is in both the MD and TD, it is the value of the relaxation factor in the MD multiplied by the relaxation factor in the TD. The relaxation factor is also preferably 1.0 or lower, more preferably 0.97 or lower and even more preferably 0.95 or lower. The relaxation factor is preferably 0.5 or higher from the viewpoint of membrane quality. The relaxation procedure may be carried out in both the MD and TD, or it may be carried out in only either of the MD or TD.

The stretching and relaxation procedures after extraction of the plasticizer are preferably carried out in the TD from the viewpoint of process control and of controlling the open hole area in 400° C. solder testing. The temperatures for the stretching and relaxation procedures are preferably lower than the melting point of the polyolefin resin (hereunder also referred to as “Tm”), and it is more preferably in the range of 1° C. to 25° C. lower than Tm. The temperatures for the stretching and relaxation procedures are preferably within this range from the viewpoint of balance between heat shrinkage factor reduction and porosity.

### Method for Disposing Porous Layer

The method of disposing the porous layers on at least one side of the PO microporous membrane may be a known disposing method, coating method, lamination method or extrusion method. For example, the PO microporous membrane may be coated with a coating solution or slurry containing the inorganic particles explained above, and optionally a resin binder and/or dispersing agent, to form a porous layer.

A method used to dispose the first porous layer on one side of the PO microporous membrane and to dispose the second porous layer on the other side of the PO microporous membrane may also be a known disposing method, coating method, lamination method or extrusion method. As another example, both sides of the PO microporous membrane may be coated with a coating solution or slurry containing the inorganic particles explained above, and optionally a resin binder and/or dispersing agent, to form a porous layer.

For the method of disposing the porous layer, the type of inorganic particle material is preferably selected from the viewpoint of the mean particle size D₅₀ of the inorganic particles in the porous layer, and from the viewpoint of compatibility with the selected inorganic particles and control of the binding points, it is preferred to select the water-soluble polymer binder and/or water-insoluble polymer binder used as the resin binder, with addition of a dispersing agent if desired, in order to provide a coating solution or slurry. The water-insoluble polymer binder that is selected is preferably in the form of a latex and more preferably in the form of an aqueous latex.

The mean particle size (D₅₀) of the water-soluble polymer in the latex is preferably adjusted according to desired reduction in inorganic particle sizes, but from the viewpoint of efficient binding at the interfaces between the inorganic particles or at the interfaces between the inorganic particles and the PO microporous membrane, the upper limit is preferably 0.20 μm or smaller, more preferably 0.15 μm or smaller, even more preferably 0.10 μm or smaller and most preferably 0.05 μm or smaller, while the lower limit is not particularly restricted and may be 0.01 μm or larger, for example.

The lower limit for the proportion of the inorganic particles is preferably 65% or higher, more preferably 70% or higher, even more preferably 75% or higher, yet more preferably 80% or higher and most preferably 85% or higher, with 100% by volume as the total of the inorganic particles, resin binder and dispersing agent in the coating solution or slurry, and the upper limit is preferably 95% or lower, more preferably 93% or lower, even more preferably 92% or lower and most preferably 91% or lower. If the volume ratio of the inorganic particles in the coating solution or slurry is within this range, the proportion of inorganic particles with respect to the other components, such as the resin binder, will be higher, thus inhibiting increase in air permeability of the PO microporous membrane due to the porous layer, and lowering the electrical resistance of the multilayer porous membrane. Increase in air permeability of the PO microporous membrane due to the porous layer can be reduced by lowering the electrical resistance of the multilayer porous membrane.

From the same viewpoint, the mass ratio of the inorganic particles in the coating solution or slurry is preferably 80% or higher, more preferably 85% or higher, even more preferably 90% or higher and most preferably 95% or higher, as the lower limit, and preferably lower than 100% and more preferably 99% or lower, as the upper limit, with 100% by weight as the total of the inorganic particles, resin binder and dispersing agent.

For formation of the inorganic particle-containing slurry or coating solution, the ratio (Wb′/Wa′), being the mass ratio Wb′ of the water-insoluble polymer binder with respect to the mass ratio Wa′ of the water-soluble polymer binder in the slurry or coating solution, is preferably higher than 1.0, more preferably 4.0 or higher and even more preferably 4.5 or higher, while the upper limit for the ratio (Wb′/Wa′) is more preferably 8.0 or lower and even more preferably 7.0 or lower, from the viewpoint of interaction between the inorganic particles and the resin binder, of increasing the number of contact points between both, and of heat resistance of the multilayer porous membrane or separator.

From the viewpoint of improving the dispersion stability or coatability, various additives such as thickeners; moistening agents; antifoaming agents; and acid- or alkali-containing pH adjustors, may be added to the coating solution or slurry. The total amount of such additives, in terms of active ingredient (mass of the dissolved additive component, when the additive is dissolved in a solvent) with respect to 100 parts by mass of the inorganic particles, is preferably 20 parts by mass or lower, more preferably 10 parts by mass or lower and even more preferably 5 parts by mass or lower.

Examples of anionic surfactant additives include higher fatty acid salts, alkylsulfonates, α-olefin sulfonates, alkane sulfonates, alkyl benzenesulfonates, sulfosuccinic acid ester salts, alkylsulfuric acid ester salts, alkyl ether sulfuric acid ester salts, alkylphosphoric acid ester salts, alkyl ether phosphoric acid ester salts, alkyl ether carboxylates, α-sulfo fatty acid methyl ester salts and methyltaurine acid salts. Examples of nonionic surfactants include glycerin fatty acid esters, polyglycerin fatty acid esters, sucrose fatty acid esters, sorbitan fatty acid esters, polyoxyethylene sorbitan fatty acid esters, polyoxyethylene alkyl ethers, polyoxyethylene alkylphenyl ethers, polyoxyethylene fatty acid esters, fatty acid alkanolamides and alkyl glucosides. Examples of amphoteric surfactants include alkyl betaines, fatty acid amide propyl betaine and alkylamine oxides. Examples of cationic surfactants include alkyltrimethylammonium salts, dialkyldimethylammonium salts, alkyldimethylbenzylammonium salts and alkylpyridinium salts, with other examples including fluorine-based surfactants, and polymer surfactants such as cellulose derivatives, polycarboxylic acid salts and polystyrenesulfonic acid salts.

The medium for the coating solution or slurry is preferably one that can uniformly and stably dissolve or disperse the inorganic particles or resin binder, and examples include N-methylpyrrolidone, N,N-dimethylformamide, N,N-dimethylacetamide, water, ethanol, toluene, hot xylene, methylene chloride and hexane.

The method of dissolving or dispersing the inorganic particles and resin binder in the coating solution medium is not particularly restricted so long as it allows the coating solution or slurry to exhibit the necessary dispersion properties for the coating step. Examples include mechanical stirring using a ball mill, bead mill, planetary ball mill, vibrating ball mill, sand mill, colloid mill, attritor, roll mill, high-speed impeller disperser, disperser, homogenizer, high-speed impact mill, ultrasonic disperser or stirring blade.

A porous layer is preferably formed by coating the surface of the polyolefin substrate layer with an inorganic particle-containing coating solution or slurry, from the viewpoint of efficiently preventing relaxation of residual stress caused by the stretching step in the separator molding step. The method of coating the coating solution or slurry onto the PO microporous membrane is not particularly restricted so long as the necessary layer thickness or coating area can be ensured, and examples include gravure coater methods, small-diameter gravure coater methods, reverse roll coater methods, transfer roll coater methods, kiss coater methods, dip coater methods, knife coater methods, air doctor coater methods, blade coater methods, rod coater methods, squeeze coater methods, cast coater methods, die coater methods, screen printing methods and spray coating methods.

According to one embodiment, the inorganic particle-containing slurry is coated onto the PO microporous membrane in such a manner the coating thickness of the porous layer on at least one side of the PO microporous membrane is preferably smaller than 5 μm, more preferably 4 μm or smaller, even more preferably 3 μm or smaller, yet more preferably 2 μm or smaller and most preferably 1 μm or smaller, with a lower limit of preferably 0.1 μm or greater and more preferably 0.5 μm or greater, from the viewpoint of inhibiting increase in air permeability of the PO microporous membrane, forming a strong porous layer, reducing the thickness of the multilayer porous membrane or separator and increasing the heat resistance (i.e. ability to inhibit heat shrinkage).

The PO microporous membrane may optionally be surface-treated prior to application of the coating solution. Surface treatment of the PO microporous membrane will facilitate application of the coating solution while improving adhesion between the coated porous layer and the PO microporous membrane surface. The method of surface treatment is not particularly restricted so long as it does not significantly impair the porous structure of the PO microporous membrane, and examples include corona discharge treatment, plasma discharge treatment, mechanical roughening methods, solvent treatment and ultraviolet oxidation methods.

The method of removing the medium from the coated membrane after application is also not particularly restricted so long as it does not adversely affect the PO microporous membrane, and examples include methods of anchoring the PO microporous membrane while drying it at a temperature below its melting point, methods of reduced pressure drying at low temperature, and methods of extraction drying. Some of the solvent may be allowed to remain so long as it does not produce any notable effect on the properties of the nonaqueous electrolyte solution battery. The multilayer porous membrane having the porous layer laminated on the PO microporous membrane preferably has its drying temperature and take-up tension appropriately adjusted from the viewpoint of controlling shrinkage stress in the MD.

### Method of Forming Thermoplastic Polymer-Containing Layer

The method for forming the thermoplastic polymer-containing layer on the PO microporous membrane or porous layer as the substrate is not particularly restricted, and an example is a method of coating the PO microporous membrane or porous layer with a coating solution comprising the thermoplastic polymer.

The method of applying the coating solution comprising the thermoplastic polymer onto the PO microporous membrane or porous layer is not particularly restricted so long as it can provide the necessary layer thickness or coating area. Examples include gravure coater methods, small-diameter gravure coater methods, reverse roll coater methods, transfer roll coater methods, kiss coater methods, dip coater methods, knife coater methods, air doctor coater methods, blade coater methods, rod coater methods, squeeze coater methods, cast coater methods, die coater methods, screen printing methods, spray coating methods, spray coater methods and ink-jet coating methods. Preferred among these are gravure coater methods or spray coating methods, from the viewpoint of a high degree of freedom for the coating shape of the thermoplastic polymer, to easily obtain the preferred area ratio. For formation of a dot pattern of the thermoplastic polymer-containing layer, preferred methods are gravure coating, ink-jet application and coating methods that allow easy adjustment of the printing plate.

If the coating solution infiltrates to the interior of the microporous membrane or porous layer when the thermoplastic polymer is coated on the PO microporous membrane, the adhesive resin will become embedded on the surfaces and interiors of the pores, lowering the permeability. The medium of the coating solution is therefore preferably a poor solvent for the thermoplastic polymer.

Using a poor solvent for the thermoplastic polymer as the medium of the coating solution is preferred from the viewpoint of inhibiting reduction in permeability, since the coating solution will fail to infiltrate into the microporous membrane or porous layer and the adhesive polymer will be present mainly on the surface of the microporous membrane. Water is a preferred medium having such properties. Media that can be used in combination with water include, but are not particularly restricted to, ethanol and methanol. An antifoaming agent may also be optionally added to the thermoplastic polymer-containing coating solution.

From the viewpoint of adhesion between the separator and the electrodes, and the viewpoint of impeding temperature increase of the separator and impeding cycle degradation for further adaptability to high-temperature storage testing, the coating material viscosity of the thermoplastic polymer-containing coating solution (hereunder also referred to as “coating material”) is preferably 30 cP or higher and more preferably 50 cP or higher, and preferably 100 cP or lower and more preferably 80 cP or lower. From the same viewpoint, the pH of the coating material is preferably 5 or higher and more preferably 5.5 or higher, and preferably 7.9 or lower and more preferably 7.7 or lower.

Surface treatment of the microporous membrane serving as the separator substrate is also preferably carried out before coating, in order to facilitate application of the coating solution and increase adhesion between the microporous membrane or porous layer and the adhesive polymer. The method of surface treatment is not particularly restricted so long as it does not significantly impair the porous structure of the microporous membrane, and examples include corona discharge treatment, plasma treatment, mechanical roughening methods, solvent treatment, acid treatment and ultraviolet oxidation.

For corona discharge treatment, the intensity of corona treatment on the substrate surface is preferably 1 W/(m²/min) or greater, more preferably 3 W/(m²/min) or greater and even more preferably 5 W/(m²/min) or greater, and also preferably 40 W/(m²/min) or lower, more preferably 32 W/(m²/min) or lower and even more preferably 25 W/(m²/min) or lower.

The method of removing the solvent from the coated membrane after coating is not particularly restricted so long as it is a method that does not adversely affect the microporous membrane or porous layer. For example, it may be a method of drying the microporous membrane and/or porous layer at a temperature below its melting point while anchoring it, a method of reduced pressure drying at low temperature, or a method of immersing it in a poor solvent for the adhesive polymer to solidify the adhesive polymer while simultaneously extracting out the solvent.

For drying of the coated membrane, the drying speed is preferably 0.03 g/(m²·s) or greater, more preferably 0.05 g/(m²·s) or greater and even more preferably 0.08 g/(m²·s) or greater, and preferably 4.0 g/(m²·s) or lower, more preferably 3.5 g/(m²·s) or lower and even more preferably 3.0 g/(m²·s) or lower. The temperature is preferably increased by warming or heating during drying of the coated membrane, to an extent that does not degrade the particle shapes in the thermoplastic polymer-containing layer.

### Nonaqueous Electrolyte Solution Battery Separator and Nonaqueous Electrolyte Solution Battery

The multilayer porous membrane of the embodiment can be used as a nonaqueous electrolyte solution battery separator, helping to ensure high-temperature insulating resistance while improving the energy density, capacity and output/cycle characteristics of the nonaqueous electrolyte solution battery. The nonaqueous electrolyte solution battery comprises a positive electrode, a separator, a negative electrode and a nonaqueous electrolyte solution, and specifically, it may be a lithium battery, lithium secondary battery, lithium ion secondary battery, sodium secondary battery, sodium ion secondary battery, magnesium secondary battery, magnesium ion secondary battery, calcium secondary battery, calcium ion secondary battery, aluminum secondary battery, aluminum ion secondary battery, nickel-hydrogen battery, nickel-cadmium battery, electrical double layer capacitor, lithium ion capacitor, redox flow battery or lithium-sulfur battery, for example. Preferred among these, from the viewpoint of practicality, are a lithium battery, lithium secondary battery, lithium ion secondary battery, nickel-hydrogen battery or lithium ion capacitor, with a lithium ion secondary battery being more preferred.

A nonaqueous electrolyte solution battery can be fabricated, for example, by stacking a positive electrode and negative electrode across a separator comprising a multilayer porous membrane as described above, if necessary winding or folding it in a hairpin fashion to form a stacked electrode body, wound electrode body or hairpin-folded body, and then packing it in an exterior body, connecting the positive and negative electrodes and the positive and negative electrode terminals of the exterior body via leads or the like, injecting a nonaqueous electrolyte solution containing a nonaqueous solvent such as a straight-chain or cyclic carbonate and an electrolyte such as a lithium salt into the exterior body, and finally sealing the exterior body.

The nonaqueous electrolyte solution battery comprises a stacked body as described above, a wound body obtained by winding the stacked body, or a hairpin-folded body obtained by hairpin-folding the stacked body, together with a nonaqueous electrolyte solution, inside an exterior body such as a cylindrical can, a pouch-type case or a laminate case. A nonaqueous electrolyte solution battery using the multilayer porous membrane of the embodiment as a separator may exhibit not only excellent safety but also excellent energy density and cycle characteristics.

When the nonaqueous electrolyte solution battery is a secondary battery, a positive electrode terminal may be welded to the edge of a positive electrode stacked body comprising a positive electrode collector and a positive electrode active material layer, while a negative electrode terminal may be welded to the edge of a negative electrode stacked body comprising a negative electrode collector and a negative electrode active material layer, so that the secondary battery comprising a terminal-attached positive electrode stacked body and a terminal-attached negative electrode stacked body can be subjected to charge-discharge.

The terminal-attached positive electrode stacked body and the terminal-attached negative electrode stacked body may then be stacked across a separator and optionally wound or hairpin-folded, and the obtained stacked body, wound body or hairpin-folded body may be housed in an exterior body, with injection of a nonaqueous electrolyte solution into the exterior body and sealing of the exterior body, to obtain a secondary battery.

When the multilayer porous membrane of the embodiment is to be used as a separator for production of a nonaqueous electrolyte solution secondary battery, the positive electrode, negative electrode and nonaqueous electrolyte solution that are used may be known ones.

The positive electrode material is not particularly restricted, and examples include lithium-containing composite oxides such as LiCoO₂, LiNiO₂, spinel-type LiMnO₄ and olivine-type LiFePO₄.

The negative electrode material is also not particularly restricted, and examples include carbon materials such as graphite, non-graphitizable carbon, easily graphitizable carbon and complex carbon; or silicon, tin, metal lithium and various alloy materials.

There are no particular restrictions on the nonaqueous electrolyte solution, and an electrolyte solution comprising an electrolyte dissolved in an organic solvent may be used. Examples of organic solvents include propylene carbonate, ethylene carbonate, dimethyl carbonate, diethyl carbonate and ethylmethyl carbonate. Examples of electrolytes include lithium salts such as LiClO₄, LiBF₄ and LiPF₆.

### EXAMPLES

The present invention will now be explained in detail through Examples and Comparative Examples, with the understanding that these Examples and Comparative Examples are not limitative on the invention.

Testing and evaluation methods

### Viscosity-Average Molecular Weight (Mv)

The limiting viscosity [η] (dl/g) at 135° C. in a decalin solvent was determined based on ASTM-D4020.

The Mv for the polyethylene and polyolefin microporous membrane were calculated by the following formula.

$$[ η ] = 6.77 \times 1 {0}^{- 4} {Mv}^{0.67}$$

For polypropylene, the Mv was calculated by the following formula.

$$[ η ] = 1.10 \times 1 {0}^{- 4} M {v}^{0.8}$$

### Polyolefin Microporous Membrane, Multilayer Porous Membrane and Thickness of Porous Layer (μm)

A “KBM™” microthickness meter by Toyo Seiki Co., Ltd. was used to measure the thicknesses of the polyolefin microporous membrane and multilayer porous membrane at room temperature (23±2° C.), and the coating thicknesses of the porous layers were each calculated from the measured thicknesses. A cross-sectional SEM image may also be used to measure the thickness of each layer, as values by detection from the multilayer porous membrane.

### Melt Index (MI) (g/10 min) of Polyolefin Microporous Membrane

The melt index (MI) of the polyolefin microporous membrane (PO microporous membrane) was measured according to JIS K7210:1999 (Plastic-thermoplastic melt mass-flow rate (MFR) and melt volume flow rate (MVR)). A 21.6 kgf load was applied to the membrane at 190° C., and the amount (g) of resin flowing out from an orifice with a diameter of 1 mm and a length of 10 mm during 10 minutes was recorded as the MI.

### Inorganic Particle Sizes, Mean Particle Size and Particle Size Distribution

In order to determine the particle size distribution and median diameter (μm) of the inorganic particle dispersion or slurry coating solution, the particle size distribution of the inorganic particle dispersion or slurry coating solution was measured using a laser particle size distribution analyzer (Microtrac MT3300EX by Nikkiso Co., Ltd.). When necessary, the particle size distribution of water or the resin binder was used as the baseline for adjustment of the particle size distribution of the inorganic particle dispersion or slurry coating solution. The particle size with 50% cumulative frequency was recorded as D₅₀, the particle size with 10% cumulative frequency was recorded as D₁₀ and the particle size with 90% cumulative frequency was recorded as D₉₀. D₅₀ is the mean particle size.

### BET Specific Surface Area of Inorganic Particles (m²/g)

The specific surface area of the inorganic particles was measured by the nitrogen adsorption BET method.

### Air Permeability (sec/100 cm³), and Ratio of Air Permeability of Multilayer Porous Membrane With Respect to Polyolefin Microporous Membrane

The air permeability of the multilayer porous membrane and the air permeability of the polyolefin microporous membrane, where the air permeability is defined as the air permeability resistance according to JIS P-8117, were measured using a “G-B2™” Gurley air permeability tester by Toyo Seiki Kogyo Co., Ltd. according to JIS P-8117, measuring the air permeability resistance of the multilayer porous membrane and polyolefin microporous membrane in an atmosphere with a temperature of 23° C. and a humidity of 40%.

The value of the air permeability of the multilayer porous membrane minus the air permeability of the polyolefin microporous membrane was calculated as the air permeability of the porous layer. The air permeability increase was calculated by the following formula:

Air permeability increase=Air permeability of porous layer/air permeability of polyolefin microporous membrane. The air permeability per thickness of the porous layer was also calculated.

### Inorganic Particle Content (% by Weight and % by Volume) in Porous Layer

The inorganic particle content in the porous layer was calculated from the mixing ratio of the constituent materials during preparation of the coating solution.

For detection from the multilayer porous membrane, a TG-DTA may be used to measure the changes in weights of the organic materials and inorganic particles. Specifically, a portion of the porous layer is scraped off from the multilayer porous membrane with a glass plate to obtain an 8 mg to 10 mg sample. The porous layer sample is set in the apparatus and the change in weight is measured in an air atmosphere while raising the temperature from room temperature to 600° C. at a temperature-elevating rate of 10° C./min, and used for calculation. The mass content ratio and volume content ratio of the inorganic particles are interchangeable based on the specific gravity of the inorganic particles.

### Porosity (%)

A 10 cm×10 cm-square sample was cut out from the microporous membrane, and its volume (cm³) and mass (g) were determined and used together with the membrane density (g/cm³) by the following formula, to obtain the porosity.

$$Porosity ( \% ) = ( Volume - mass / density ) / volume \times 100$$

### Puncture Strength (N) and Basis Weight-Equivalent Puncture Strength (N/(g/m²))

Using a Handy Compression Tester “KES-G5™” by Kato Tech Corp., the microporous membrane or multilayer porous membrane was anchored with a specimen holder having an opening diameter of 11.3 mm. Next, the center section of the anchored microporous membrane or multilayer porous membrane was subjected to a puncture test with a needle having a tip curvature radius of 0.5 mm, at a puncture speed of 2 mm/sec and in an atmosphere with a temperature of 23° C. and a humidity of 40%, the raw puncture strength (gf) being obtained as the maximum puncture load. The value of the obtained puncture strength (N) in terms of basis weight (N/(g/m²)) was also calculated.

### Mean Pore Diameter of Porous Layer

Obtaining cross-sectional SEM image of resin-embedded sample

After dyeing the multilayer porous membrane with ruthenium and embedding it an ordinary temperature-curing epoxy resin, smooth cross-sections parallel to the TD were fabricated using a broad ion beam (BIB), and were observed with a scanning electron microscope (SEM) and imaged at 7000× to obtain an SEM image. From a smooth cross-section it is possible to obtain multiple SEM images in multiple visual fields, or to obtain a single SEM image in a single visual field. A SEM image was obtained with the entire thickness of the multilayer porous layer fitted into the visual field of the SEM. A region cut out from the multilayer porous layer to exclude 3% of the upper and lower thickness of the multilayer porous layer was subjected to image analysis as described below. For multiple SEM images, the SEM images were taken at 50 μm spacings in the lengthwise direction of the smooth cross-section.
Image analysis and pore diameter analysis

The obtained SEM image was subjected to median filter treatment under conditions with a radius of 2.0 pixels, and then binarized by the Otsu method under Threshold conditions, calculating the area ratio of the black sections and/or white sections. The binarized image was then subjected to pore diameter analysis by the Local Thickness method, and the pore diameter distribution, mean pore diameter and maximum pore diameter were calculated. The Local Thickness method can be carried out by thickness analysis using “BoneJ”, a plugin for the image processing software “ImageJ”, and if the size of the maximum circle fitting into the location of interest is defined as the space size, this allows the space size to be defined even without independent structure/independent spaces, for calculation of the pore diameter distribution, mean pore diameter and maximum pore diameter.
Results of pore diameter analysis

At least one SEM image taken for each of the smooth cross-sections parallel to the TD, fabricated in BIB as described above, was subjected to pore diameter analysis by the Local Thickness method, and the mean pore diameter d, pore diameter distribution D, standard deviation of the pore diameter distribution D and pore diameter maximum PS were calculated.

In addition, five SEM images taken for each of the smooth cross-sections parallel to the TD fabricated in BIB, as described above, were subjected to pore diameter analysis by the Local Thickness method, and the standard deviation for the mean pore diameter d was calculated.

### Moisture Content Per Unit Volume of Porous Layer

The multilayer porous membrane was cut out to a mass of 0.15 g to 0.20 g and pretreated for 12 hours at 23° C., 40% relative humidity. The weight was then measured and recorded as the sample weight (g). The moisture weight (μg) of the pretreated sample was measured using a Karl Fischer apparatus. The heating vaporization conditions during measurement were 150° C. for 10 minutes. The cathode reagent used was a HYDRANAL COULOMAT CG-K (product of Sigma-Aldrich), and the anode reagent used was a HYDRANAL COULOMAT AK (product of Sigma-Aldrich).

The measured moisture weight (μg), sample weight (g), porous layer thickness (μm) and multilayer porous membrane weight per unit area (g/m²) were used to calculate the moisture content per unit volume of the porous layer, using the following formula.

Moisture weight per unit volume (mg/(μm·m²))=Moisture weight/(porous layer thickness×sample weight/weight of multilayer porous membrane per unit area)/1000

### Dry Heat Shrinkage Factor (%) at 130° C. and 150° C.

A multilayer porous membrane sample was cut out to 100 mm in the MD and 100 mm in the TD, and allowed to stand for 1 hour in an oven at 130° C. or 150° C. During this time, the sample was sandwiched between ten sheets of paper so as to avoid direct contact of the sample with warm air. After removing the sample from the oven and cooling it, the length (mm) was measured and the heat shrinkage factor was calculated by the following formula. Measurement was performed in the MD and TD, representing the heat shrinkage factors as the averages for each.

$$Heat shrinkage factor ( \% ) = \{ ( 100 - length after heating ) / 100 \} \times 100$$

### Measurement of Light Transmittance (%)

The light transmittance of each sample was measured with the following sample size, measuring device and measuring conditions.
Sample size: 5 cm×5 cm
Measuring device: UV/visible/near-infrared spectrophotometer V-630 by JASCO Corp.
Measuring conditions: uptake interval of 1 nm, scanning speed of 400 nm/min, measuring range of 390 nm to 850 nm

For measurement of the light transmittance, a polyolefin microporous membrane and multilayer porous membrane may be used as samples to obtain light transmittance (%) for each at a wavelength of 550 nm.

### Ratio of Light Transmittance of Multilayer Porous Membrane and Light Transmittance of Polyolefin Microporous Membrane at 550 nm

The light transmittances of the polyolefin microporous membrane before coating and of the multilayer porous membrane after coating were each measured as described above, and the ratio of the light transmittance of the multilayer porous membrane at 550 nm and the light transmittance of the polyolefin microporous membrane at 550 nm was calculated based on the following formula.

Light transmittance ratio=light transmittance of multilayer porous membrane at 550 nm (%)/light transmittance of polyolefin microporous membrane at 550 nm (%)

The porous layers were removed from each of the multilayer porous membranes obtained in the Examples and Comparative Examples, and the ratio of the light transmittance was calculated in the same manner. Specifically, the multilayer porous membrane cut out to a size of 100 cm² was immersed for 24 hours in 10 mL of water, and then the porous layer was scraped with a spatula or similar tool and used as a sample for ultrasonic irradiation with an ultrasonic irradiator to remove the porous layer. The light transmittances of the polyolefin microporous membrane from which the porous layer had been removed and of the multilayer porous membrane before removal were measured. The ratio of the light transmittance of the multilayer porous membrane and the light transmittance of the polyolefin microporous membrane at a wavelength of 550 nm calculated in this manner was confirmed to be approximately the same as the ratio of the light transmittance of the multilayer porous membrane at 550 nm and the light transmittance of the polyolefin microporous membrane at 550 nm mentioned above.

### 90° Peel Strength (N/m)

One side of a multilayer porous membrane piece cut out to 2 mm×7 mm, opposite the covering layer measured side, was attached to a glass plate using double-sided tape, and tape (product name: “Mending Tape MP-12” by 3M) was attached to the covering layer. A 5 mm portion at the tip of the tape was peeled off, and using a tensile tester (model AG-IS, SLBL-1kN by Shimadzu Corp.), one end of the tape was gripped with a chuck, peeling the tape at an angle of 90° with respect to the in-plane direction of the multilayer porous membrane. A tensile test was conducted with a pull rate of 300 mm/sec, a temperature of 25° and a relative humidity of 40%, for measurement of the tensile strength (N/m).

### 180° Peel Strength (N/m)

One side of a multilayer porous membrane piece cut out to 2 mm×7 mm, opposite the covering layer measured side, was attached to a glass plate using double-sided tape, and tape (product name: “Mending Tape MP-12” by 3M) was attached to the covering layer. A 5 mm portion at the tip of the tape was peeled off, and using a tensile tester (model AG-IS, SLBL-1kN by Shimadzu Corp.), one end of the tape was gripped with a chuck, peeling the tape at an angle of 180° with respect to the in-plane direction of the multilayer porous membrane. A tensile test was conducted with a pull rate of 50 mm/sec, a temperature of 25° and a relative humidity of 40%, for measurement of the tensile strength (N/m).

### Glass Transition Temperature (° C.) of Thermoplastic Polymer

A sufficient amount of the thermoplastic polymer coating solution (nonvolatile content=30%) was placed in an aluminum tray and dried for 30 minutes in a hot air drier at 130° C. Approximately 17 mg of the dried film was packed into a measuring aluminum container, and the DSC curve and DDSC curve were obtained using a DSC measuring apparatus (DSC6220 by Shimadzu Corp.) under a nitrogen atmosphere. The measuring conditions were as follows.

### First Stage Temperature Increase Program

70° C. start, temperature increase at 15° C./minute. The temperature was maintained for 5 minutes after reaching 110° C.

### Second Stage Temperature Decrease Program

Temperature decrease from 110° C. at 40° C./minute. The temperature was maintained for 5 minutes after reaching −50° C.

### Third Stage Temperature Increase Program

Temperature increase from −50° C. to 130° C. at 15° C./minute. DSC and DDSC data recorded during third stage heating.

The intersection between the baseline (an extended straight line toward the high-temperature end from the baseline of the obtained DSC curve) and the tangent line at the inflection point (the point where the upwardly convex curve changed to a downwardly convex curve) was recorded as the glass transition temperature (Tg).

### Dot Diameter and Dot Distance

The dot diameter of the coating pattern of the thermoplastic polymer-containing coating solution was measured using a microscope (model: VHX-7000 by Keyence Corp.). The separator sample was photographed at 100× magnification (coaxial illumination), and the diameters of multiple dots (5 points) were measured in measuring mode, calculating their average as the dot diameter. Using the distance from the outer edge section of a given dot to the outer edge section of the nearest adjacent dot as the “dot distance”, measurement was performed in measuring mode at 5 points, taking their average to calculate the dot distance.

### Adhesion to Electrodes

The multilayer porous membranes or separators obtained for each of the Examples and Comparative Examples, and negative electrodes (product of Enertech, negative electrode material: graphite, conductive aid: acetylene black, L/W: 20 mg/cm² for both sides, Cu current collector thickness: 10 μm, pressed negative electrode thickness: 140 μm) as adherends, were each cut out to rectangular shapes with widths of 15 mm and lengths of 60 mm, and were respectively stacked with the thermoplastic polymer-containing layer of the multilayer porous membrane or separator facing the negative electrode active material to obtain stacked bodies, which were then pressed under the following conditions.
Press pressure: 1 MPa
Temperature: 90° C.
Pressing time: 1 minute
   For each of the pressed stacked bodies, ZP5N and MX2-500N (product names) force gauges by Imada Co., Ltd. were used for a 90° peel test at a peel rate of 50 mm/min, with a pulling system in which the electrodes were anchored and the multilayer porous membrane or separator was held and pulled to measure the peel strength. The average for the peel strength in the peel test with a length of 40 mm, carried out under the conditions described above, was recorded as the adhesive force with the electrode. The adhesive force was measured before and after soaking the stacked body with propylene carbonate (PC), representing the adhesive force before PC impregnation as the Dry adhesive force and the adhesive force after PC impregnation as the Wet adhesive force. When a separator exhibiting adhesive force of preferably 1.0 N/m or greater and more preferably 1.8 N/m or greater according to this method is used in a nonaqueous electrolyte solution battery, the exhibited force of adhesion with the facing positive electrode and negative electrode is satisfactory. The adhesive force is preferably 100.0 N/m or lower from the viewpoint of ion resistance.

### Battery Temperature Increase Test

A positive electrode, multilayer porous membrane and negative electrode fabricated by the method described below were stacked in that order, and the long sides of the positive electrode, multilayer membrane and negative electrode were wound to a width of 30 mm and were stored in an aluminum laminate film, with heat sealing on 3 sides.

A positive electrode lead tab and negative electrode lead tab were each drawn out from one side of the laminate film.

After drying the heat sealed sample, the following electrolyte solution was injected into the laminate film and the remaining side was sealed to prepare a test battery.

The test battery was designed for a capacity of 1 Ah.

The fabricated battery was charged to 4.2 V with a discharge current of 0.5 C, in an environment at 25° C. The charged battery was loaded into an oven, the temperature was increased from room temperature to 180° C. at 5° C./min, and the test results were evaluated for the battery surface temperature at the point where the voltage fell to ≤2 V, using the criteria specified below.

### Fabrication of Positive Electrode

There were uniformly mixed: a mixed positive electrode active material comprising lithium-nickel-manganese-cobalt composite oxide powder (LiNi_{1/3}Mn_{1/3}Co_{1/3}O₂) and lithium-manganese composite oxide powder (LiMn₂O₄), mechanically mixed at a mass ratio of 70:30, as a positive electrode active material: 85 parts by mass, acetylene black as a conductive aid: 6 parts by mass, and PVdF as a binder: 9 parts by mass, with N-methyl-2-pyrrolidone (NMP) as the solvent, to prepare a positive electrode mixture-containing paste. The positive electrode mixture-containing paste was evenly coated onto both sides of a 20 μm-thick current collector made of aluminum foil and dried, after which it was compression molded with a roll press, adjusting the thickness of the positive electrode mixture layer to a total thickness of 100 μm. A positive electrode was fabricated having a non-active material-coated aluminum foil with a length of 20 mm as a lead tab on a short side top section of a rectangular sheet with 50 mm short sides and 350 mm long sides.

### Fabrication of Negative Electrode

Graphite as a negative electrode active material: 91 parts by mass, and PVdF as a binder: 9 parts by mass, were mixed to uniformity with NMP as the solvent, to prepare a negative electrode mixture-containing paste. The negative electrode mixture-containing paste was evenly coated onto both sides of a 15 μm-thick current collector made of copper foil and dried, after which it was compression molded with a roll press, adjusting the thickness of the negative electrode mixture layer to a total thickness of 100 μm. A negative electrode was fabricated having a non-active material-coated copper foil with a length of 20 mm as a lead tab on a short side top section of a rectangular sheet with 52 mm short sides and 352 mm long sides.

### Preparation of Electrolyte Solution

LiPF₆ was dissolved to a concentration of 1.0 mol/L in a mixed solvent of ethylene carbonate and ethylmethyl carbonate at 1:1 (volume ratio), to prepare a nonaqueous electrolyte solution.

### Preparation of Multilayer Porous Membrane

A 54 mm×360 mm sample was cut out from the multilayer porous membranes obtained in the Examples and Comparative Examples.

### Evaluation Scale for Battery Temperature Increase Test

A: Battery surface temperature of 170° C. or higher,
B: Battery surface temperature of 165° C. or higher,
C: Battery surface temperature of 160° C. or higher,
D: Battery surface temperature of lower than 160° C.

### Rate Characteristic

a. Fabrication of Positive Electrode

A slurry was prepared by dispersing 91.2 parts by mass of lithium-nickel-manganese-cobalt composite oxide (Li[Ni_{1/3}Mn_{1/3}Co_{1/3}]O₂) as a positive electrode active material, 2.3 parts by mass each of scaly graphite and acetylene black as conductive materials, and 4.2 parts by mass of polyvinylidene fluoride (PVdF) as a resin binder, in N-methylpyrrolidone (NMP). The slurry was coated using a die coater onto one side of aluminum foil with a thickness of 20 μm as the positive electrode, to a positive electrode active material coating amount of 120 g/m². After 3 minutes of drying at 130° C., a roll press was used for compression molding to a positive electrode active material bulk density of 2.90 g/cm³, to produce a positive electrode. The positive electrode was punched out to a circle with an area of 2.00 cm².

b. Fabrication of Negative Electrode

A slurry was prepared by dispersing 96.6 parts by mass of artificial graphite as a negative electrode active material, 1.4 parts by mass of carboxymethyl cellulose ammonium salt as a resin binder and 1.7 parts by mass of styrene-butadiene copolymer latex, in purified water. The slurry was coated using a die coater onto one side of copper foil with a thickness of 16 μm as the negative electrode collector, to a negative electrode active material coating amount of 53 g/m². After 3 minutes of drying at 120° C., a roll press was used for compression molding to a negative electrode active material bulk density of 1.35 g/cm³, to produce a negative electrode. This was punched out to a circle with an area of 2.05 cm².

c. Preparation of Nonaqueous Electrolyte Solution

A 1.0 ml/L portion of concentrated LiPF₆, as a solute, was dissolved in a mixed solvent of ethylene carbonate:ethyl carbonate=1:2 (volume ratio), to prepare a nonaqueous electrolyte solution.

d. Battery Assembly

The negative electrode, multilayer porous membrane and positive electrode were stacked in that order from the bottom with the active material sides of the positive electrode and negative electrode facing each other. The stack was housed in a covered stainless steel metal container, with the container body and cover insulated, and with the copper foil of the negative electrode and the aluminum foil of the positive electrode each contacting with the container body and cover, to obtain a cell. The battery was dried under reduced pressure at 70° C. for 10 hours. A nonaqueous electrolyte solution was then injected into the container in an argon box and the battery was sealed as a battery for evaluation.

e. Evaluation of Rate Characteristic

Each battery assembled as described in (d. Battery assembly) above was subjected to initial charge after battery fabrication, for a total of approximately 6 hours, to a cell voltage of 4.2 V at a temperature of 25° C. and a current value of 3 mA (˜0.5 C), with initial drawing out of the current value from 3 mA while maintaining 4.2 V, and then to discharge up to a cell voltage of 3.0 V at a current value of 3 mA.

Next, the battery was subjected to charge for a total of approximately 3 hours, by a method of charge to a cell voltage of 4.2 V at a current value of 6 mA (˜1.0 C) at 25° C. with initial drawing out of the current value from 6 mA while maintaining 4.2 V, and then to discharge up to a cell voltage of 3.0 V at a current value of 6 mA, obtaining the service capacity at that time as the 1 C service capacity (mAh).

Next, the battery was subjected to charge for a total of approximately 3 hours, by a method of charge to a cell voltage of 4.2 V at a current value of 6 mA (˜1.0 C) at 25° C. with initial drawing out of the current value from 6 mA while maintaining 4.2 V, and then to discharge up to a cell voltage of 3.0 V at a current value of 60 mA (˜10 C), obtaining the service capacity at that time as the 10 C service capacity (mAh).

The ratio of the 10 C service capacity with respect to the 1 C service capacity was calculated and the value was recorded as the rate characteristic.

Rate characteristic at 10 C (%)=(10 C service capacity/1 C service capacity)×100

The rate characteristic at 10 C was evaluated on the following scale.
A: 10 C rate characteristic of ≥22%
B: 10 C rate characteristic of ≥20% and <22%
C: 10 C rate characteristic of ≥18% and <20%
D: 10 C rate characteristic of <18%

### Cycle Test

The battery tested in <Rate characteristic> above was discharged at a discharge current of 1 C to a final discharge voltage of 3 V at a temperature of 25° C., and then charged at a charging current of 1 C to a final charge voltage of 4.2 V. Charge-discharge was repeated with this procedure as 1 cycle. The capacity retention after 300 cycles with respect to the initial capacity (the capacity at the first cycle) was used to evaluate the cycle characteristic on the following scale.
A: Capacity retention of ≥65%.
B: Capacity retention of ≥60% and <65%.
C: Capacity retention of <60%.

### Measurement of Contaminant Detection Rate

Contaminants on the polyolefin microporous membrane on which the porous layer had been formed in the multilayer porous membrane (contaminants including unmelted resin, metal powder and carbides) were examined using an optical contaminant inspection device with an examination range having a width of 1,000 to 1,300 mm and a length of 1,000 m, and the contaminant detection rate was calculated and evaluated on the following scale.

### Evaluation Scale

A: Contamination detection rate: 95% to 100%,
B: Contamination detection rate: ≥90% and <95%,
C: Contamination detection rate: ≥85% and <90%,
D: Contamination detection rate: <85%

### Example 1

A tumbler blender was used to form a polymer blend comprising 46.5% by weight (wt %) of homopolymer polyethylene (PE) with a viscosity-average molecular weight (Mv) of 700,000, 46.5 wt % of homopolymer PE with an Mv of 250,000 and 7 wt % of homopolymer polypropylene (PP) with an Mv of 400,000. To 99 parts by weight of the polymer blend there was added 1 part by weight of pentaerythrityl-tetrakis-[3-(3,5-di-t-butyl-4-hydroxyphenyl)propionate] as an antioxidant, and a tumbler blender was again used for dry blending to obtain a polymer mixture. The obtained polymer mixture was substituted with nitrogen and then supplied to a twin-screw extruder using a feeder under a nitrogen atmosphere. Also, liquid paraffin (kinematic viscosity at 37.78° C.: 7.59×10⁻⁵ m²/s) was injected into the extruder cylinder by a plunger pump.

The mixture was melt kneaded with adjustment of the feeder and pump for a liquid paraffin quantity ratio of 68 wt % in the total extruded mixture (resin composition concentration: 32 wt %). The melt kneading conditions were a preset temperature of 200° C., a screw rotational speed of 70 rpm and a discharge throughput of 145 kg/h.

The melt kneaded mixture was then extrusion cast through a T-die onto a cooling roll controlled to a surface temperature of 25° C., to obtain a gel sheet with a thickness of 1350 μm.

The gel sheet was then simultaneously fed into a biaxial tenter stretching machine for biaxial stretching. The stretching conditions were an MD factor of 7.0, a TD factor of 6.4 and a preset temperature of 122° C. The sheet was subsequently fed into a methylene chloride tank and thoroughly immersed in the methylene chloride for extraction removal of the liquid paraffin, after which the methylene chloride was dried off to obtain a porous body.

The porous body was fed to a TD tenter and heat set. The heat setting temperature was 132° C., the maximum TD factor was 1.85 and the relaxation factor was 0.784, and this yielded a polyolefin microporous membrane (PO microporous membrane D) with a thickness (TB) of 6.0 um. The resin composition and measurement results for the obtained polyolefin microporous membrane are shown in Table 1.

After this, inorganic particles having the particle sizes (D10 or D90), mean particle size (D₅₀), particle size distribution (D90/D50 or D50/D10) and BET specific surface area shown in Table 2 were used for mixing of the water-soluble polymer binder, water-insoluble polymer binder and additives with the inorganic particles, as shown in Table 3 and Table 4, and then a suitable amount of water and a dispersing agent were mixed in and the mixture was stirred to form a dispersion. When necessary, bead mill treatment was carried out under conditions with a bead diameter of 0.1 mm and a rotational speed of 2000 rpm inside the mill. Xantham gum was also added as a thickener to the treated liquid mixture when necessary, to prepare a coating solution.

The surface of the polyolefin microporous membrane was subjected to corona discharge treatment, after which a gravure coater was used to coat the treated surface with the coating solution. After then drying the coating solution on the polyolefin microporous membrane at 60° C. to remove the water, a porous layer with a thickness of 1.0 μm comprising 95.8% by weight (89.3% by volume) of inorganic particles was formed on one side of the polyolefin microporous membrane to obtain a multilayer porous membrane. Table 4 shows the membrane properties of the obtained multilayer porous membrane, and the evaluation results of a battery comprising the multilayer porous membrane as a separator.

### Examples 2 to 20 and Comparative Examples 1 to 3

Multilayer porous membranes were formed in the same manner as Example 1, except that the production conditions and physical properties of the polyolefin microporous membranes, and the types of inorganic particles, the types of constituent components of the porous layer, the coating solution compositions and the coating conditions, were set as shown in Tables 1 to 4. The properties of the obtained multilayer porous membrane and a battery comprising it as a separator were evaluated by the method described above. The evaluation results are shown in Table 4.

In Example 3, a thermoplastic polymer-containing adhesive layer was formed in a dotted manner on the surface of the multilayer porous membrane. For Example 14, a porous layer comprising inorganic particles and a resin binder was formed on both sides of PO microporous membrane B.

TABLE 1

| | | PO | PO | PO | PO | PO |
|---|---|---|---|---|---|---|
| PO microporous | | microporous | microporous | microporous | microporous | microporous |
| membrane | — | membrane B | membrane C | membrane D | membrane E | membrane G |
| Polyethylene | wt % | 100 | 100 | 93 | 100 | 100 |
| percentage | | | | | | |
| Polypropylene | wt % | 0 | 0 | 7 | 0 | 0 |
| percentage | | | | | | |
| MI | g/10 min | 0.15 | 0.15 | 0.47 | 0.15 | 0.60 |
| Membrane thickness | μm | 9.0 | 4.5 | 6.0 | 7.0 | 10.0 |
| Porosity | % | 46 | 37 | 41 | 42 | 36 |
| Air permeability | sec/100 cm³ | 90 | 85 | 95 | 90 | 170 |
| Puncture strength | gf | 470 | 300 | 300 | 380 | 540 |
| Basis weight- | N/(g/m²) | 1.00 | 1.09 | 0.88 | 0.97 | 0.88 |
| equivalent strength | | | | | | |
| Gas-liquid pore | nm | 59 | 50 | 55 | — | 63 |
| diameter | | | | | | |
| Half-dry pore | nm | 52 | — | 42 | — | 43 |
| diameter | | | | | | |

TABLE 2

| | | Boehm- | Boehm- | Boehm- | Boehm- |
|---|---|---|---|---|---|
| Inorganic particles | | ite A | ite B | ite C | ite D |
| D₁₀ particle size | μm | 0.15 | 0.23 | 0.1 | 0.44 |
| D₅₀ particle size | μm | 0.25 | 0.45 | 0.15 | 0.65 |
| D₉₀ particle size | μm | 0.49 | 0.68 | 0.25 | 1.1 |
| D₉₀/D₅₀ | — | 2.0 | 1.5 | 1.7 | 1.7 |
| D₅₀/D₁₀ | — | 1.7 | 2.0 | 1.5 | 1.5 |
| BET specific | m²/g | 14 | 7 | 25 | 5 |
| surface area | | | | | |
| Aspect ratio | — | 1.3 | 1.4 | 1.3 | 1.3 |

TABLE 3

| | | PAAM | PAAM | PAAM | PAAM | PAAM | PAAM | PAAM | PAAM | PAAM |
|---|---|---|---|---|---|---|---|---|---|---|
| Water-soluble binder | | 1 | 2 | 3 | 4 | 5 | 6 | 7 | 9 | 10 |
| (Meth)acrylamide | wt % | 83 | 69 | 77 | 96 | 97 | 71 | 75 | 96 | 100 |
| monomer | | | | | | | | | | |
| percentage | | | | | | | | | | |
| Acrylonitrile | wt % | 14 | 24 | 18 | 4 | 3 | 21 | 21 | 4 | 0 |
| monomer | | | | | | | | | | |
| percentage | | | | | | | | | | |
| (Meth)acrylic | wt % | 3 | 7 | 5 | 0 | 0 | 8 | 4 | 0 | 0 |
| acid monomer | | | | | | | | | | |
| percentage | | | | | | | | | | |
| Acrylate | wt % | 0 | 0 | 0 | 0 | 0 | 0 | 0 | 0 | 0 |
| monomer | | | | | | | | | | |
| percentage | | | | | | | | | | |
| (including | | | | | | | | | | |
| derivatives) | | | | | | | | | | |
| Other percentage | wt % | 0 | 0 | 0 | 0 | 0 | 0 | 0 | 0 | 0 |
| Other backbone | — | — | — | — | — | — | — | — | — | — |
| Weight-average | x10,000 | 34 | 39 | 100 | 150 | 40 | 37 | 39 | 52 | 100 |
| molecular weight | | | | | | | | | | |
| Mw | | | | | | | | | | |
| Number-average | x10,000 | 6 | 6 | 4 | 6 | 13 | 7 | 10 | 10 | 9 |
| molecular weight | | | | | | | | | | |
| Mn | | | | | | | | | | |
| Mw/Mn | — | 6 | 6 | 25 | 25 | 3 | 5 | 4 | 5 | 9 |

TABLE 4

| | | | Example 1 | Example 2 | Example 3 |
|---|---|---|---|---|---|
| PO microporous membrane | | — | PO microporous | PO microporous | PO microporous |
| | | | membrane D | membrane B | membrane B |
| Porous | Inorganic particle type | — | Boehmite A | Boehmite A | Boehmite A |
| layer | Water-soluble binder type | — | PAAM 1 | PAAM 1 | PAAM 1 |
| | Water-insoluble binder type | — | Acrylic latex | Acrylic latex | Acrylic latex |
| | Water-insoluble binder D50 | μm | 0.14 | 0.14 | 0.14 |
| | particle size | | | | |
| | Dispersing agent type | — | Sodium | Sodium | Sodium |
| | | | polycarboxylate | polycarboxylate | polycarboxylate |
| | Inorganic particle weight ratio | wt % | 95.8 | 95.1 | 95.1 |
| | Water-soluble binder weight | wt % | 0.6 | 0.6 | 0.6 |
| | ratio Wa | | | | |
| | Water-insoluble binder weight | wt % | 3.1 | 3.8 | 3.8 |
| | ratio Wb | | | | |
| | Dispersing agent weight ratio | wt % | 0.6 | 0.6 | 0.6 |
| | Wb/Wa | — | 5.3 | 6.7 | 6.7 |
| | Thickness | μm | 1.0 | 2.0 | 2.0 |
| | Air permeability | sec/100 | 7.0 | 14.0 | 14.0 |
| | | cm³ | | | |
| | Air permeability per unit | (sec/100 | 7.0 | 7.0 | 7.0 |
| | thickness | cm³)μm | | | |
| | Density | g/(μm · m²) | 1.5 | 1.6 | 1.6 |
| | Moisture content per unit | mg/(μm · m²) | 2.4 | 2.4 | 2.4 |
| | volume | | | | |
| | Mean pore diameter of porous | nm | 120 | 120 | 120 |
| | layer | | | | |
| | Porous layer pore | — | 2.2 | 2.0 | 2.0 |
| | diameter/substrate layer gas- | | | | |
| | liquid pore diameter | | | | |
| Multilayer | Thickness | μm | 7.0 | 11.0 | 11.0 |
| porous | Porous layer thickness/PO | — | 0.17 | 0.22 | 0.22 |
| membrane | microporous membrane thickness | | | | |
| properties | Air permeability | sec/100 | 102 | 104 | 104 |
| | | cm³ | | | |
| | Air permeability increase rate | — | 0.07 | 0.16 | 0.16 |
| | Puncture strength | gf | 300 | 470 | 470 |
| | 130° C.-Dry heat shrinkage MD | % | 1 | 1 | 1 |
| | 130° C.-Dry heat shrinkage TD | % | 1 | 1 | 1 |
| | 150° C.-Dry heat shrinkage MD | % | 24 | 2 | 2 |
| | 150° C.-Dry heat shrinkage TD | % | 27 | 2 | 2 |
| | 90° Peel strength | N/m | 12 | 20 | 20 |
| | 180° Peel strength | N/m | 255 | 306 | 306 |
| | Ratio between light transmittance of | — | — | — | — |
| | coated membrane at 550 nm and light | | | | |
| | transmittance of substrate at 550 nm | | | | |
| | Light transmittance of multilayer | % | — | — | — |
| | porous membrane at 550 nm | | | | |
| Adhesive | Dot diameter | μm | — | — | 200 |
| layer | Dot distance | μm | — | — | 450 |
| Battery | Temperature increase test | — | C | B | B |
| evaluation | Rate test | — | A | B | B |
| | Cycle test | — | B | B | A |
| | Contaminant detectability | — | — | — | — |
| | | | Example 4 | Example 5 | Example 6 |
| PO microporous membrane | | — | PO microporous | PO microporous | PO microporous |
| | | | membrane E | membrane D | membrane D |
| Porous | Inorganic particle type | — | Boehmite A | Boehmite A | Boehmite A |
| layer | Water-soluble binder type | — | PAAM 1 | PAAM 2 | PAAM 3 |
| | Water-insoluble binder type | — | Acrylic latex | Acrylic latex | Acrylic latex |
| | Water-insoluble binder D50 | μm | 0.14 | 0.14 | 0.14 |
| | particle size | | | | |
| | Dispersing agent type | — | Sodium | Sodium | Sodium |
| | | | polycarboxylate | polycarboxylate | polycarboxylate |
| | Inorganic particle weight ratio | wt % | 95.1 | 95.8 | 95.8 |
| | Water-soluble binder weight | wt % | 0.6 | 1.0 | 0.6 |
| | ratio Wa | | | | |
| | Water-insoluble binder weight | wt % | 3.8 | 2.7 | 3.1 |
| | ratio Wb | | | | |
| | Dispersing agent weight ratio | wt % | 0.6 | 0.6 | 0.6 |
| | Wb/Wa | — | 6.7 | 2.8 | 5.3 |
| | Thickness | μm | 1.5 | 1.0 | 1.0 |
| | Air permeability | sec/100 | 10.5 | 7.0 | 7.5 |
| | | cm³ | | | |
| | Air permeability per unit | (sec/100 | 7.0 | 7.0 | 7.5 |
| | thickness | cm³) μm | | | |
| | Density | g/(μm · m²) | 1.6 | 1.5 | 1.5 |
| | Moisture content per unit | mg/(μm · m²) | 2.4 | 2.2 | 3.1 |
| | volume | | | | |
| | Mean pore diameter of porous | nm | 120 | 120 | 120 |
| | layer | | | | |
| | Porous layer pore | — | — | 2.2 | 2.2 |
| | diameter/substrate layer gas- | | | | |
| | liquid pore diameter | | | | |
| Multilayer | Thickness | μm | 8.5 | 7.0 | 7.0 |
| porous | Porous layer thickness/PO | — | 0.21 | 0.17 | 0.17 |
| membrane | microporous membrane thickness | | | | |
| properties | Air permeability | sec/100 | 100 | 102 | 102 |
| | | cm³ | | | |
| | Air permeability increase rate | — | 0.12 | 0.07 | 0.08 |
| | Puncture strength | gf | 380 | 300 | 300 |
| | 130° C.-Dry heat shrinkage MD | % | 1 | 1 | 2 |
| | 130° C.-Dry heat shrinkage TD | % | 1 | 1 | 2 |
| | 150° C.-Dry heat shrinkage MD | % | 1 | 47 | 47 |
| | 150° C.-Dry heat shrinkage TD | % | 1 | 48 | 48 |
| | 90° Peel strength | N/m | 18 | 12 | 14 |
| | 180° Peel strength | N/m | 286 | 235 | 286 |
| | Ratio between light transmittance of | — | — | — | — |
| | coated membrane at 550 nm and light | | | | |
| | transmittance of substrate at 550 nm | | | | |
| | Light transmittance of multilayer | % | — | — | — |
| | porous membrane at 550 nm | | | | |
| Adhesive | Dot diameter | μm | — | — | — |
| layer | Dot distance | μm | — | — | — |
| Battery | Temperature increase test | — | B | C | C |
| evaluation | Rate test | — | A | B | B |
| | Cycle test | — | B | B | B |
| | Contaminant detectability | — | — | — | — |
| | | | Example 7 | Example 8 | Example 9 |
| PO microporous membrane | | — | PO microporous | PO microporous | PO microporous |
| | | | membrane D | membrane D | membrane G |
| Porous | Inorganic particle type | — | Boehmite A | Boehmite A | Boehmite A |
| layer | Water-soluble binder type | — | PAAM 4 | PAAM 5 | PAAM 6 |
| | Water-insoluble binder type | — | Acrylic latex | Acrylic latex | Acrylic latex |
| | Water-insoluble binder D50 | μm | 0.14 | 0.14 | 0.14 |
| | particle size | | | | |
| | Dispersing agent type | — | Sodium | Sodium | Sodium |
| | | | polycarboxylate | polycarboxylate | polycarboxylate |
| | Inorganic particle weight ratio | wt % | 95.8 | 95.8 | 95.8 |
| | Water-soluble binder weight | wt % | 0.6 | 0.6 | 0.6 |
| | ratio Wa | | | | |
| | Water-insoluble binder weight | wt % | 3.1 | 3.1 | 3.1 |
| | ratio Wb | | | | |
| | Dispersing agent weight ratio | wt % | 0.6 | 0.6 | 0.6 |
| | Wb/Wa | — | 5.3 | 5.3 | 5.3 |
| | Thickness | μm | 1.0 | 1.0 | 1.0 |
| | Air permeability | sec/100 | 8.0 | 8.5 | 7.0 |
| | | cm³ | | | |
| | Air permeability per unit | (sec/100 | 8.0 | 8.5 | 7.0 |
| | thickness | cm³)μm | | | |
| | Density | g/(μm · m²) | 1.5 | 1.5 | 1.5 |
| | Moisture content per unit | mg/(μm · m²) | 2.8 | 3.2 | 2.1 |
| | volume | | | | |
| | Mean pore diameter of porous | nm | 120 | 120 | 120 |
| | layer | | | | |
| | Porous layer pore | — | 2.2 | 2.2 | 1.9 |
| | diameter/substrate layer gas- | | | | |
| | liquid pore diameter | | | | |
| Multilayer | Thickness | μm | 7.0 | 7.0 | 11.0 |
| porous | Porous layer thickness/PO | — | 0.17 | 0.17 | 0.10 |
| membrane | microporous membrane thickness | | | | |
| properties | Air permeability | sec/100 | 103 | 104 | 177 |
| | | cm³ | | | |
| | Air permeability increase rate | — | 0.08 | 0.09 | 0.04 |
| | Puncture strength | gf | 300 | 300 | 540 |
| | 130° C.-Dry heat shrinkage MD | % | 2 | 2 | 1 |
| | 130° C.-Dry heat shrinkage TD | % | 2 | 2 | 1 |
| | 150° C.-Dry heat shrinkage MD | % | 47 | 48 | 2 |
| | 150° C.-Dry heat shrinkage TD | % | 48 | 49 | 2 |
| | 90° Peel strength | N/m | 14 | 12 | 16 |
| | 180° Peel strength | N/m | 269 | 235 | 255 |
| | Ratio between light transmittance of | — | — | — | — |
| | coated membrane at 550 nm and light | | | | |
| | transmittance of substrate at 550 nm | | | | |
| | Light transmittance of multilayer | % | — | — | — |
| | porous membrane at 550 nm | | | | |
| Adhesive | Dot diameter | μm | — | — | — |
| layer | Dot distance | μm | — | — | — |
| Battery | Temperature increase test | — | B | B | B |
| evaluation | Rate test | — | B | B | C |
| | Cycle test | — | B | B | C |
| | Contaminant detectability | — | — | — | — |
| | | | Example 10 | Example 11 | Example 12 |
| PO microporous membrane | | — | PO microporous | PO microporous | PO microporous |
| | | | membrane G | membrane G | membrane C |
| Porous | Inorganic particle type | — | Boehmite A | Boehmite A | Boehmite B |
| layer | Water-soluble binder type | — | PAAM 7 | PAAM 9 | PAAM 2 |
| | Water-insoluble binder type | — | Acrylic latex | Acrylic latex | Acrylic latex |
| | Water-insoluble binder D50 | μm | 0.14 | 0.14 | 0.14 |
| | particle size | | | | |
| | Dispersing agent type | — | Sodium | Sodium | Sodium |
| | | | polycarboxylate | polycarboxylate | polycarboxylate |
| | Inorganic particle weight ratio | wt % | 95.8 | 95.8 | 95.8 |
| | Water-soluble binder weight | wt % | 0.6 | 0.6 | 1.0 |
| | ratio Wa | | | | |
| | Water-insoluble binder weight | wt % | 3.1 | 3.1 | 2.7 |
| | ratio Wb | | | | |
| | Dispersing agent weight ratio | wt % | 0.6 | 0.6 | 0.6 |
| | Wb/Wa | — | 5.3 | 5.3 | 2.8 |
| | Thickness | μm | 2.0 | 2.0 | 2.0 |
| | Air permeability | sec/100 | 14.0 | 14.0 | 14.0 |
| | | cm³ | | | |
| | Air permeability per unit | (sec/100 | 7.0 | 7.0 | 7.0 |
| | thickness | cm³)μm | | | |
| | Density | g/(μm · m²) | 1.5 | 1.5 | 1.5 |
| | Moisture content per unit volume | mg/(μm · m²) | 2.1 | 2.3 | — |
| | Mean pore diameter of porous | nm | 120 | 120 | 250 |
| | layer | | | | |
| | Porous layer pore | — | 1.9 | 1.9 | 5.0 |
| | diameter/substrate layer gas- | | | | |
| | liquid pore diameter | | | | |
| Multilayer | Thickness | μm | 12.0 | 12.0 | 6.5 |
| porous | Porous layer thickness/PO | — | 0.20 | 0.20 | 0.44 |
| membrane | microporous membrane thickness | | | | |
| properties | Air permeability | sec/100 | 184 | 184 | 99 |
| | | cm³ | | | |
| | Air permeability increase rate | — | 0.08 | 0.08 | 0.16 |
| | Puncture strength | gf | 540 | 540 | 300 |
| | 130° C.-Dry heat shrinkage MD | % | 1 | 1 | 1 |
| | 130° C.-Dry heat shrinkage TD | % | 1 | 1 | 1 |
| | 150° C.-Dry heat shrinkage MD | % | 2 | 1 | 1 |
| | 150° C.-Dry heat shrinkage TD | % | 2 | 1 | 1 |
| | 90° Peel strength | N/m | 16 | 16 | 17 |
| | 180° Peel strength | N/m | 255 | 286 | 245 |
| | Ratio between light transmittance of | — | — | — | — |
| | coated membrane at 550 nm and light | | | | |
| | transmittance of substrate at 550 nm | | | | |
| | Light transmittance of multilayer | % | — | — | — |
| | porous membrane at 550 nm | | | | |
| Adhesive | Dot diameter | μm | — | — | — |
| layer | Dot distance | μm | — | — | — |
| Battery | Temperature increase test | — | A | B | B |
| evaluation | Rate test | — | C | C | A |
| | Cycle test | — | C | C | B |
| | Contaminant detectability | — | — | — | — |
| | | | Example 13 | Example 14 | Example 15 |
| PO microporous membrane | | — | PO microporous | PO microporous | PO microporous |
| | | | membrane D | membrane B | membrane D |
| Porous | Inorganic particle type | — | Boehmite C | Boehmite A | Boehmite A |
| layer | Water-soluble binder type | — | PAAM 1 | PAAM 1 | PAAM 1 |
| | Water-insoluble binder type | — | Acrylic latex | Acrylic latex | Acrylic latex |
| | Water-insoluble binder D50 | μm | 0.14 | 0.14 | 0.14 |
| | particle size | | | | |
| | Dispersing agent type | — | Sodium | Sodium | Sodium |
| | | | polycarboxylate | polycarboxylate | polycarboxylate |
| | Inorganic particle weight ratio | wt % | 94.7 | 95.1 | 95.5 |
| | Water-soluble binder weight | wt % | 0.6 | 0.6 | 0.6 |
| | ratio Wa | | | | |
| | Water-insoluble binder weight | wt % | 3.8 | 3.8 | 3.3 |
| | ratio Wb | | | | |
| | Dispersing agent weight ratio | wt % | 0.9 | 0.6 | 0.6 |
| | Wb/Wa | — | 6.7 | 6.7 | 5.8 |
| | Thickness | μm | 1.0 | 1.0 + 1.0 | 1.5 |
| | Air permeability | sec/100 | 7.0 | 7.0 | 10.0 |
| | | cm³ | | | |
| | Air permeability per unit | (sec/100 | 7.0 | 7.0 | 7 |
| | thickness | cm³)μm | | | |
| | Density | g/(μm · m²) | 1.6 | 1.6 | 1.5 |
| | Moisture content per unit | mg/(μm · m²) | 3.4 | 2.4 | — |
| | volume | | | | |
| | Mean pore diameter of porous | nm | 70 | 120 | — |
| | layer | | | | |
| | Porous layer pore | — | 1.3 | 2.0 | — |
| | diameter/substrate layer gas- | | | | |
| | liquid pore diameter | | | | |
| Multilayer | Thickness | μm | 7.0 | 11.0 | 7.5 |
| porous | Porous layer thickness/PO | — | 0.17 | 0.11 | 0.25 |
| membrane | microporous membrane thickness | | | | |
| properties | Air permeability | sec/100 | 102 | 104 | 105 |
| | | cm³ | | | |
| | Air permeability increase rate | — | 0.07 | 0.16 | 0.11 |
| | Puncture strength | gf | 300 | 470 | 300 |
| | 130° C.-Dry heat shrinkage MD | % | 1 | 1 | 1 |
| | 130° C.-Dry heat shrinkage TD | % | 1 | 1 | 1 |
| | 150° C.-Dry heat shrinkage MD | % | 3 | 2 | 1 |
| | 150° C.-Dry heat shrinkage TD | % | 7 | 2 | 1 |
| | 90° Peel strength | N/m | 10 | 18 | — |
| | 180° Peel strength | N/m | 245 | 286 | — |
| | Ratio between light transmittance of | — | — | — | 0.42 |
| | coated membrane at 550 nm and light | | | | |
| | transmittance of substrate at 550 nm | | | | |
| | Light transmittance of multilayer | % | — | — | 3.4 |
| | porous membrane at 550 nm | | | | |
| Adhesive | Dot diameter | μm | — | — | — |
| layer | Dot distance | μm | — | — | — |
| Battery | Temperature increase test | — | B | A | B |
| evaluation | Rate test | — | B | B | A |
| | Cycle test | — | B | B | B |
| | Contaminant detectability | — | — | — | B |
| | | | Example 16 | Example 17 | Example 18 |
| PO microporous membrane | | — | PO microporous | PO microporous | PO microporous |
| | | | membrane D | membrane D | membrane C |
| Porous | Inorganic particle type | — | Boehmite C | Boehmite C | Boehmite C |
| layer | Water-soluble binder type | — | PAAM 1 | PAAM 1 | PAAM 1 |
| | Water-insoluble binder type | — | Acrylic latex | Acrylic latex | Acrylic latex |
| | Water-insoluble binder D50 | μm | 0.14 | 0.14 | 0.08 |
| | particle size | | | | |
| | Dispersing agent type | — | Sodium | Sodium | Sodium |
| | | | polycarboxylate | polycarboxylate | polycarboxylate |
| | Inorganic particle weight ratio | wt % | 95.1 | 95.5 | 95.8 |
| | Water-soluble binder weight | wt % | 1.4 | 0.6 | 0.6 |
| | ratio Wa | | | | |
| | Water-insoluble binder weight | wt % | 2.9 | 3.3 | 3.1 |
| | ratio Wb | | | | |
| | Dispersing agent weight ratio | wt % | 0.6 | 0.6 | 0.6 |
| | Wb/Wa | — | 2.0 | 5.8 | 5.3 |
| | Thickness | μm | 0.5 | 3.0 | 1.0 |
| | Air permeability | sec/100 | 8.0 | 37.0 | 15.0 |
| | | cm³ | | | |
| | Air permeability per unit | (sec/100 | 16 | 12 | 15 |
| | thickness | cm³)μm | | | |
| | Density | g/(μm · m²) | 1.4 | 1.5 | 1.5 |
| | Moisture content per unit | mg/(μm · m²) | — | — | — |
| | volume | | | | |
| | Mean pore diameter of porous | nm | — | — | — |
| | layer | | | | |
| | Porous layer pore | — | — | — | — |
| | diameter/substrate layer gas- | | | | |
| | liquid pore diameter | | | | |
| Multilayer | Thickness | μm | 6.5 | 9.0 | 5.5 |
| porous | Porous layer thickness/PO | — | 0.08 | 0.50 | 0.22 |
| membrane | microporous membrane thickness | | | | |
| properties | Air permeability | sec/100 | 103 | 132 | 100 |
| | | cm³ | | | |
| | Air permeability increase rate | — | 0.08 | 0.39 | 0.18 |
| | Puncture strength | gf | 300 | 300 | 300 |
| | 130° C.-Dry heat shrinkage MD | % | 1 | 1 | 1 |
| | 130° C.-Dry heat shrinkage TD | % | 1 | 1 | 1 |
| | 150° C.-Dry heat shrinkage MD | % | 4 | 0 | 1 |
| | 150° C.-Dry heat shrinkage TD | % | 5 | 0 | 1 |
| | 90° Peel strength | N/m | — | — | — |
| | 180° Peel strength | N/m | — | — | — |
| | Ratio between light transmittance of | — | 0.97 | 0.79 | 0.95 |
| | coated membrane at 550 nm and light | | | | |
| | transmittance of substrate at 550 nm | | | | |
| | Light transmittance of multilayer | % | 8.1 | 6.5 | 8.1 |
| | porous membrane at 550 nm | | | | |
| Adhesive | Dot diameter | μm | — | — | — |
| layer | Dot distance | μm | — | — | — |
| Battery | Temperature increase test | — | B | A | A |
| evaluation | Rate test | — | A | C | A |
| | Cycle test | — | B | C | B |
| | Contaminant detectability | — | A | A | A |

| | | | Example 19 | Example 20 |
|---|---|---|---|---|
| PO microporous membrane | | — | PO microporous | PO microporous |
| | | | membrane C | membrane B |
| Porous | Inorganic particle type | — | Boehmite C | Boehmite A |
| layer | Water-soluble binder type | — | PAAM 1 | PAAM 1 |
| | Water-insoluble binder type | — | Acrylic latex | Acrylic latex |
| | Water-insoluble binder D50 | μm | 0.15 | 0.08 |
| | particle size | | | |
| | Dispersing agent type | — | Sodium | Sodium |
| | | | polycarboxylate | polycarboxylate |
| | Inorganic particle weight ratio | wt % | 95.8 | 95.1 |
| | Water-soluble binder weight | wt % | 0.6 | 0.6 |
| | ratio Wa | | | |
| | Water-insoluble binder weight | wt % | 3.1 | 3.8 |
| | ratio Wb | | | |
| | Dispersing agent weight ratio | wt % | 0.6 | 0.6 |
| | Wb/Wa | — | 5.3 | 6.7 |
| | Thickness | μm | 1.0 | 2.0 |
| | Air permeability | sec/100 | 15.0 | 16.0 |
| | | cm³ | | |
| | Air permeability per unit | (sec/100 | 15 | 8 |
| | thickness | cm³)μm | | |
| | Density | g/(μm · m²) | 1.5 | 1.6 |
| | Moisture content per unit | mg/(μm · m²) | — | 2.5 |
| | volume | | | |
| | Mean pore diameter of porous | nm | — | 120 |
| | layer | | | |
| | Porous layer pore | — | — | 2.0 |
| | diameter/substrate layer gas- | | | |
| | liquid pore diameter | | | |
| Multilayer | Thickness | μm | 5.5 | 11.0 |
| porous | Porous layer thickness/PO | — | 0.22 | 0.22 |
| membrane | microporous membrane thickness | | | |
| properties | Air permeability | sec/100 | 97 | 106 |
| | | cm³ | | |
| | Air permeability increase rate | — | 0.14 | 0.18 |
| | Puncture strength | gf | 300 | 470 |
| | 130° C.-Dry heat shrinkage MD | % | 1 | 1 |
| | 130° C.-Dry heat shrinkage TD | % | 1 | 1 |
| | 150° C.-Dry heat shrinkage MD | % | 1 | 1 |
| | 150° C.-Dry heat shrinkage TD | % | 1 | 1 |
| | 90° Peel strength | N/m | — | 24 |
| | 180° Peel strength | N/m | — | 326 |
| | Ratio between light transmittance of | — | 0.94 | — |
| | coated membrane at 550 nm and light | | | |
| | transmittance of substrate at 550 nm | | | |
| | Light transmittance of multilayer | % | 8.2 | — |
| | porous membrane at 550 nm | | | |
| Adhesive | Dot diameter | μm | — | — |
| layer | Dot distance | μm | — | — |
| Battery | Temperature increase test | — | B | B |
| evaluation | Rate test | — | A | B |
| | Cycle test | — | B | B |
| | Contaminant detectability | — | A | — |

| | | | Comp. | Comp. | Comp. |
|---|---|---|---|---|---|
| | | | Example 1 | Example 2 | Example 3 |
| PO microporous membrane | | — | PO microporous | PO microporous | PO microporous |
| | | | membrane D | membrane D | membrane D |
| Porous | Inorganic particle type | — | Boehmite A | Boehmite D | Boehmite B |
| layer | Water-soluble binder type | — | PAAM 10 | PAAM 1 | PAAM 10 |
| | Water-insoluble binder type | — | Acrylic latex | Acrylic latex | Acrylic latex |
| | Water-insoluble binder D50 | μm | 0.14 | 0.14 | 0.15 |
| | particle size | | | | |
| | Dispersing agent type | — | Sodium | Sodium | Sodium |
| | | | polycarboxylate | polycarboxylate | polycarboxylate |
| | Inorganic particle weight ratio | wt % | 95.8 | 95.8 | 95.8 |
| | Water-soluble binder weight | wt % | 0.6 | 0.6 | 0.3 |
| | ratio Wa | | | | |
| | Water-insoluble binder weight | wt % | 3.1 | 3.1 | 3.4 |
| | ratio Wb | | | | |
| | Dispersing agent weight ratio | wt % | 0.6 | 0.6 | 0.6 |
| | Wb/Wa | — | 5.3 | 5.3 | 11.7 |
| | Thickness | μm | 1.0 | 1.0 | 1.5 |
| | Air permeability | sec/100 | 6.5 | 7.0 | 8.0 |
| | | cm³ | | | |
| | Air permeability per unit | (sec/100 | 6.5 | 7.0 | 5.3 |
| | thickness | cm³)μm | | | |
| | Density | g/(μm · m²) | 1.5 | 1.5 | 1.6 |
| | Moisture content per unit | mg/(μm · m²) | 2.5 | — | — |
| | volume | | | | |
| | Mean pore diameter of porous | nm | 120 | 350 | 250 |
| | layer | | | | |
| | Porous layer pore | — | 2.2 | 6.4 | 6.4 |
| | diameter/substrate layer gas- | | | | |
| | liquid pore diameter | | | | |
| Multilayer | Thickness | μm | 7.0 | 7.0 | 7.5 |
| porous | Porous layer thickness/PO | — | 0.17 | 0.17 | 0.25 |
| membrane | microporous membrane thickness | | | | |
| properties | Air permeability | sec/100 | 102 | 102 | 103 |
| | | cm³ | | | |
| | Air permeability increase rate | — | 0.07 | 0.07 | 0.08 |
| | Puncture strength | gf | 300 | 300 | 300 |
| | 130° C.-Dry heat shrinkage MD | % | 2 | 6 | — |
| | 130° C.-Dry heat shrinkage TD | % | 2 | 6 | — |
| | 150° C.-Dry heat shrinkage MD | % | 42 | 50 | — |
| | 150° C.-Dry heat shrinkage TD | % | 44 | 51 | — |
| | 90° Peel strength | N/m | 17 | 15 | — |
| | 180° Peel strength | N/m | 204 | 224 | — |
| | Ratio between light transmittance of | — | — | — | 0.19 |
| | coated membrane at 550 nm and light | | | | |
| | transmittance of substrate at 550 nm | | | | |
| | Light transmittance of multilayer | % | — | — | 1.6 |
| | porous membrane at 550 nm | | | | |
| Adhesive | Dot diameter | μm | — | — | — |
| layer | Dot distance | μm | — | — | — |
| Battery | Temperature increase test | — | D | D | D |
| evaluation | Rate test | — | A | A | B |
| | Cycle test | — | B | B | B |
| | Contaminant detectability | — | — | — | — |

1. A multilayer porous membrane having a microporous membrane comprising a polyolefin resin as a main component, and a porous layer that contains inorganic particles and a water-soluble polymer binder, layered on at least one side of the microporous membrane, wherein:
an air permeability of the multilayer porous membrane is 300 sec/100 cm³ or lower,
a thickness of the porous layer on at least one side of the microporous membrane is 0.01 μm or greater and less than 5.00 μm,
a mean particle size D₅₀ of the inorganic particles is 0.01 μm or greater and less than 0.50 μm, and
the water-soluble polymer binder comprises a (meth)acrylamide-derived monomer unit at greater than 30.0% by weight and 99.0% by weight or lower and a cyano group-containing monomer unit at 1.0% by weight or greater and lower than 70.0% by weight.

2. The multilayer porous membrane according to claim 1, wherein a basis weight-equivalent puncture strength of the microporous membrane is 0.49 N/(g/m²) or greater.

3. The multilayer porous membrane according to claim 1, wherein an air permeability of the porous layer is 100 sec/100 cm³ or lower.

4. The multilayer porous membrane according to claim 1, wherein the water-soluble polymer binder is non-particulate, and a weight-average molecular weight of the water-soluble polymer binder is 300,000 or higher.

5. The multilayer porous membrane according to claim 1, wherein the water-soluble polymer binder comprises a (meth)acrylic acid monomer unit at less than 20.0% by weight.

6. The multilayer porous membrane according to claim 1, wherein the multilayer porous membrane comprises a water-insoluble polymer binder.

7. The multilayer porous membrane according to claim 1, wherein a 150° C. heat shrinkage factor of the multilayer porous membrane is 10% or lower in both the MD and TD.

8. The multilayer porous membrane according to claim 1, wherein the multilayer porous membrane is a nonaqueous electrolyte solution battery separator.

9. A nonaqueous electrolyte solution battery comprising a positive electrode, the multilayer porous membrane according to claim 1, a negative electrode and a nonaqueous electrolyte solution.
